(19) United States
(12) Patent Application Publication
(10) Pub. No.: US 2026/0289327 A1
(43) Pub. Date: Sep. 24, 2026

(54) SYSTEM

(71) Applicant: SoftBank Group Corp., Tokyo (JP)

(72) Inventor: Yuya ONO, Tokyo (JP)

(73) Assignee: SoftBank Group Corp., Tokyo (JP)

(21) Appl. No.: 19/562,947

(22) Filed: Mar. 11, 2026

(30) Foreign Application Priority Data
Mar. 19, 2025 (JP) 2025-044996

(51) Int. Cl. G06N 3/10; G06N 3/0475

(52) U.S. Cl. CPC G06N 3/105; G06N 3/0475

(57) ABSTRACT

A system includes a processor that is configured to process data at high speed by performing parallel processing on the data, train a machine learning model using past datasets, and analyze data by inputting a prompt sentence into a generative AI model.

### CROSS-REFERENCE TO RELATED APPLICATION

This application is based on and claims priority under 35 USC 119 from Japanese Patent Application No. 2025-044996 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional data processing systems suffer from limitations in processing speed, predictive accuracy, and flexibility when handling large and diverse datasets. In particular, traditional architectures often execute data processing in a sequential manner, resulting in significant latency when dealing with high-volume or high-velocity data streams. Furthermore, many existing systems require manual construction and tuning of analytical models, and are not capable of efficiently leveraging past datasets to automatically improve model performance over time. In addition, current solutions typically lack seamless integration between conventional machine learning models and generative AI models, thereby constraining the ability to perform advanced data analysis such as contextual understanding or complex pattern extraction based on natural language input. As a result, users face difficulties in achieving rapid, accurate, and industry-adaptable data analysis in real time, particularly in environments where immediate decision support is required.

### SUMMARY

To solve the above problems, the invention provides a system comprising a processor configured to process data at high speed by performing parallel processing on the data, thereby reducing processing time for large-scale or high-velocity datasets. The processor is further configured to train a machine learning model using past datasets so that predictive performance and analytical accuracy are automatically improved as additional historical data becomes available. Moreover, the processor is configured to analyze data by inputting a prompt sentence into a generative AI model, thereby enabling natural language-based, context-aware analysis that complements conventional machine learning output. In some embodiments, the processor is configured to analyze data in real time by using artificial intelligence technology and to output results promptly, enabling immediate feedback and decision support. In other embodiments, the processor is configured to train a model using industry-specific datasets in order to generate a model specialized for data analysis in a particular industry, thereby enhancing applicability and accuracy for domain-focused use cases. Through these combined functionalities, the system enables high-speed, high-accuracy, and adaptable data analysis that addresses the limitations of conventional systems.

The term “system” refers to an arrangement of one or more hardware and/or software components that cooperate to perform data processing, analysis, and model training as described in the claims.

The term “processor” refers to one or more hardware processing units, such as a central processing unit (CPU), graphics processing unit (GPU), or specialized accelerator, and may include associated circuitry and firmware configured to execute instructions to implement the claimed functions.

The term “data” refers to any kind of information in digital form, including but not limited to numerical values, categorical values, text, images, logs, transaction records, and time-series information that can be processed by the system.

The term “parallel processing” refers to a mode of processing in which multiple data items, tasks, or computational operations are executed concurrently, for example across multiple cores, processors, or threads, to increase overall processing throughput and reduce latency.

The term “high speed” refers to a processing performance level in which data is processed with reduced latency and increased throughput relative to conventional sequential processing methods, such that large volumes of data can be handled within a practically acceptable time frame.

The term “past datasets” refers to previously collected or stored data, including historical records of events, transactions, measurements, or logs, which are used as training data for machine learning models.

The term “machine learning model” refers to a computational model that is trained using data so as to learn patterns or relationships, and that is capable of performing tasks such as prediction, classification, clustering, or regression based on learned parameters.

The term “training” refers to a process in which a machine learning model adjusts its internal parameters or structure using one or more datasets so as to minimize an error metric or optimize a performance criterion.

The term “generative AI model” refers to an artificial intelligence model, such as a generative neural network or large language model, that is configured to generate outputs, including text or other data, based on learned probabilistic relationships from training data.

The term “prompt sentence” refers to an input expression, which may be in natural language or a structured format, provided to the generative AI model in order to specify a task, context, query, or instruction for subsequent analysis or generation.

The term “analyze data” refers to performing computational operations on data to derive information, insights, patterns, predictions, or summaries, including but not limited to classification, statistical analysis, feature extraction, and inference.

The term “artificial intelligence technology” refers to computational techniques and algorithms, including but not limited to machine learning, deep learning, and generative modeling, that enable a system to automatically learn from data, detect patterns, and make inferences or decisions.

The term “real time” refers to a processing mode in which data is received, analyzed, and output with sufficiently low latency such that the results can be used immediately or near-immediately for ongoing operations or decision making.

The term “results” refers to outputs generated by the processor after executing data processing, analysis, or model-based inference, including but not limited to predictions, classifications, scores, visualizations, and reports.

The term “industry-specific datasets” refers to datasets that contain information characteristic of a particular industry or domain, such as finance, healthcare, manufacturing, or retail, and that reflect domain-specific attributes, terminology, and patterns.

The term “model specialized for data analysis in a particular industry” refers to a machine learning or AI model that has been trained or adapted using industry-specific datasets so as to exhibit improved performance, accuracy, or relevance for tasks within that particular industry.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

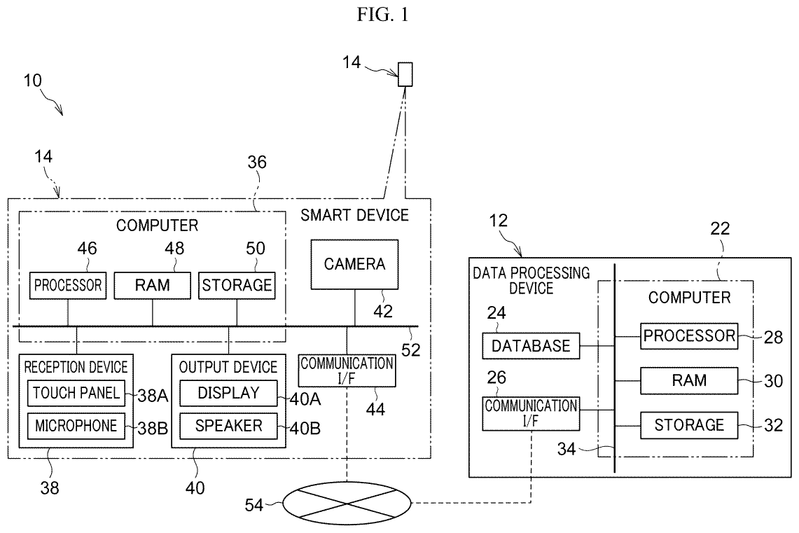

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

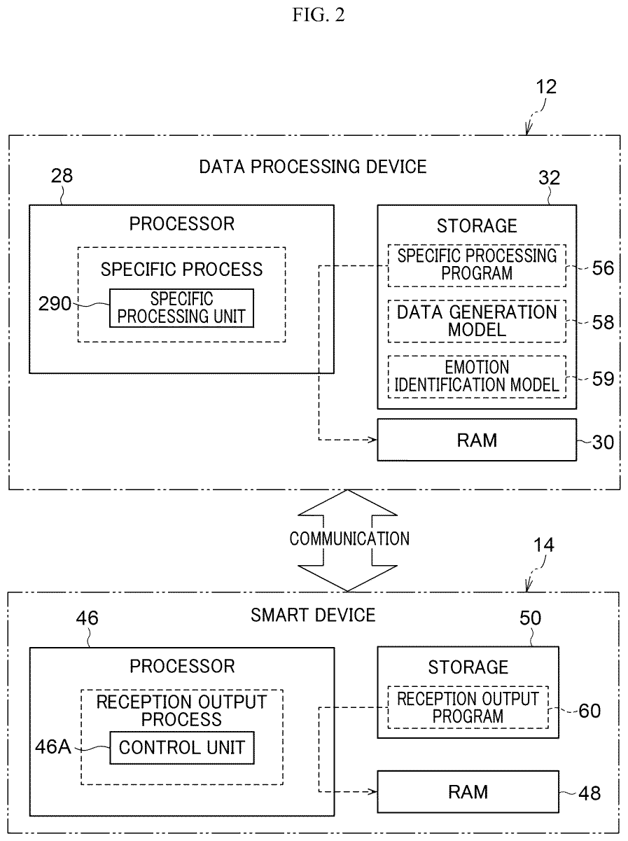

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional data analysis systems that employ machine learning or artificial intelligence typically implement a fixed sequence of preprocessing, model execution, and result output that is manually configured by developers. Such systems often treat user input, including natural-language descriptions of analysis objectives, as mere labels or parameter settings, rather than as dynamic instructions for configuring the end-to-end analysis pipeline. As a result, these systems suffer from several technical limitations.

First, existing systems lack an integrated mechanism by which a processor can automatically interpret a natural-language prompt sentence and translate it into concrete computational operations, such as selection of target attributes, determination of an analysis task type, selection of an appropriate model, and specification of an output format. Because these decisions are usually hard-coded or require manual reconfiguration, the system cannot efficiently adapt to diverse analysis intents in real time, causing increased latency, redundant computation, and rigid workflows.

Second, although parallel computation devices such as accelerators are widely used for machine learning inference and training, many systems fail to coordinate preprocessing operations and downstream model execution in a manner that is dynamically optimized per request. In particular, preprocessing for heterogeneous data types (for example, tabular data versus image data) is often implemented as separate, static modules. This leads to inefficient utilization of computational resources, additional data conversion overhead, and difficulty in maintaining performance guarantees when switching among multiple analysis tasks.

Third, conventional systems generally generate only raw numerical outputs (for example, scores, labels, or bounding boxes) and rely on separate, manually crafted logic to produce textual explanations or visualization data. There is no tightly coupled architecture in which a generative AI model consumes both a user's prompt sentence and structured analysis results to produce coherent, task-specific natural-language explanations and visualization-ready data. Consequently, users must interpret low-level outputs themselves, which increases cognitive load and reduces the practical usability of the system, particularly for complex analyses such as anomaly detection or trend and seasonality analysis.

Fourth, when adapting models to specific industrial fields, many systems either rely on static, domain-specific models or require extensive manual tuning and scripting to align the analysis pipeline with field-specific data types, attributes, and evaluation indices. These approaches make it difficult for the processor to automatically construct or update specialized data-analysis and explanation-generation models based on high-level domain instructions, thereby limiting scalability and hindering efficient deployment across multiple domains.

Accordingly, there is a need for a computer-implemented system in which a processor is configured to: (i) receive heterogeneous data and perform data-type-specific preprocessing; (ii) execute machine learning models on parallel computation devices; (iii) interpret natural-language prompt sentences to dynamically configure an analysis pipeline; (iv) invoke a generative AI model to generate natural-language explanations that are tightly coupled with the analysis results; (v) generate visualization data suitable for real-time presentation; and (vi) construct or update specialized models for particular industrial fields based on prompt-driven task interpretation. Such a system would improve the functioning of the computer itself by enabling more efficient use of computational resources, reducing manual configuration overhead, and providing adaptive, prompt-driven analysis and explanation capabilities that are not achievable with conventional static pipelines.

The specific processing by the specific processing unit 290 of the data processing device 12 in Example 1 is realized by the following means.

The present invention provides a server comprising a processor and at least one storage device, the processor being configured to receive data from a terminal via an input interface and store the data in the storage device; determine a type of the stored data and perform data-type-specific preprocessing including, for tabular data, at least missing-value completion, normalization, and encoding, and, for image data, at least size conversion, pixel-value normalization, and color-space conversion, thereby generating preprocessed data; input the preprocessed data to a machine learning model executed by a parallel computation device and perform data analysis processing including at least one of feature extraction, classification, prediction, and anomaly detection; acquire a prompt sentence in natural language input from the terminal and execute task-interpretation processing that specifies at least one of a target attribute, an analysis task, and an output format of the data analysis processing based on contents of the prompt sentence; select or configure the machine learning model or an analysis algorithm in accordance with content specified by the task-interpretation processing, and dynamically control an analysis pipeline for the preprocessed data based on the selection or configuration; execute a generative AI model using the prompt sentence, a result of the data analysis processing, and related metadata as inputs, and generate natural-language explanation information including at least a summary, a rationale, and a commentary regarding the analysis result; generate visualization data including, for tabular data, list information, statistical information, and graph information, and including, for image data, region-highlighting information and annotation information, based on the result of the data analysis processing and the natural-language explanation information, and transmit the visualization data to the terminal in real time; and execute information-protection processing including at least prevention of unauthorized access, encryption, and access control for the data and the analysis result. This enables the server to improve the functioning of the computer by automatically translating natural-language prompt sentences into dynamically configured, data-type-aware analysis pipelines executed on parallel computation devices, by tightly integrating machine learning outputs with generative AI-based explanations and visualization data, and by adaptively constructing or updating domain-specialized analysis and explanation models, thereby reducing manual configuration, increasing computational efficiency, and providing more intelligible and responsive analysis results to the user.

The term “processor” refers to a hardware computing element, or a combination of such elements, that executes machine instructions to perform logical and arithmetic operations, control program flow, and manage data movement within the server.

The term “terminal” refers to an information processing apparatus, such as a client computer, a mobile device, or a browser-equipped device, that transmits data and prompt sentences to the server and receives analysis results and visualization data from the server.

The term “input device” refers to a hardware or software interface through which the server receives data or instructions from the terminal, including network interfaces, application programming interfaces, and communication ports that handle incoming electronic messages.

The term “storage device” refers to a non-transitory computer-readable medium, such as a memory device or a persistent storage apparatus, that stores data, models, intermediate processing results, and configuration information used by the processor.

The term “parallel computation device” refers to a hardware accelerator, such as a multi-core processing unit, a vector processing unit, or a specialized computation unit, that performs multiple arithmetic operations concurrently to accelerate machine learning or data analysis processing.

The term “data” refers to digital information, including but not limited to tabular records, images, time-series measurements, logs, and metadata, that is processed by the server for analysis.

The term “tabular data” refers to data organized in a structured format comprising rows and columns, where each column represents a feature or attribute and each row represents an instance or record.

The term “image data” refers to digital representations of visual information, typically encoded as arrays of pixel values in one or more color channels, and stored in formats such as raster images.

The term “preprocessing” refers to a series of computational operations applied to raw data to improve data quality, consistency, and suitability for subsequent machine learning or analysis, including but not limited to cleansing, transformation, normalization, and feature encoding.

The term “missing-value completion” refers to a processing operation that detects absent or undefined values in data and replaces them with substitute values, such as statistical estimates, default values, or model-based predictions.

The term “normalization” refers to a transformation of numerical data into a standardized range or distribution, such as rescaling values to a predetermined interval or adjusting them to a specified mean and variance.

The term “encoding” refers to a transformation that converts categorical or symbolic data into numerical representations, such as one-hot vectors or index-based codes, that can be processed by machine learning models.

The term “size conversion” refers to an operation that changes the spatial dimensions or resolution of image data, such as resizing an image to a predetermined width and height.

The term “pixel-value normalization” refers to a transformation of raw pixel intensity values to a standardized numerical range or distribution, such as scaling values from a discrete interval to a continuous interval suitable for model input.

The term “color-space conversion” refers to a transformation of image data from one color representation scheme to another, such as converting between different color models, to meet the requirements of downstream processing or models.

The term “preprocessed data” refers to data that has undergone one or more preprocessing operations, such as missing-value completion, normalization, encoding, size conversion, pixel-value normalization, or color-space conversion, and is prepared for input to a machine learning model or analysis algorithm.

The term “machine learning model” refers to a computational model trained using example data to learn statistical patterns or mappings between inputs and outputs, and configured to perform tasks such as classification, regression, feature extraction, or anomaly detection.

The term “data analysis processing” refers to computational operations performed on preprocessed data by one or more models or algorithms to derive information such as predictions, classifications, extracted features, detected anomalies, or other analytical results.

The term “feature extraction” refers to a process that derives informative representations or attributes from raw or preprocessed data, which are used as inputs to downstream models or for analysis.

The term “classification” refers to a process that assigns input data to one or more discrete categories or labels, based on patterns learned by a machine learning model.

The term “prediction” refers to a process that estimates unknown values or future states based on historical data and learned relationships, including but not limited to regression outputs or probabilistic forecasts.

The term “anomaly detection” refers to a process that identifies data instances that deviate significantly from expected behavior or from patterns learned from typical data, and that may represent errors, outliers, or rare events.

The term “prompt sentence” refers to a sequence of characters or tokens expressed in a natural language and provided by a user through the terminal, which describes an analysis objective, constraint, or desired output to guide the server's processing.

The term “task-interpretation processing” refers to a computational procedure that analyzes a prompt sentence to infer and specify at least one of a target attribute, an analysis task, and an output format, and that generates control information for configuring an analysis pipeline accordingly.

The term “analysis pipeline” refers to an ordered set of processing stages, including preprocessing, model execution, post-processing, and result generation, that is applied to data in order to produce analysis results.

The term “analysis algorithm” refers to a computational procedure, distinct from or combined with a machine learning model, that operates on data to perform an analytical function such as clustering, statistical summarization, or rule-based evaluation.

The term “generative AI model” refers to a computational model trained using machine learning techniques to generate new data or content, including natural-language text, based on input data, learned patterns, and internal parameters.

The term “natural-language explanation information” refers to text generated in a human-readable language that describes, summarizes, or interprets analysis results, and may include a summary, a rationale, and a commentary.

The term “summary” refers to a condensed representation of analysis results that highlights main findings or key statistics without listing all underlying data.

The term “rationale” refers to an explanation describing why certain results were produced, including references to data attributes, thresholds, or patterns that influenced a model's output.

The term “commentary” refers to additional descriptive text that contextualizes results, indicates implications, or provides interpretive remarks beyond raw numerical outputs.

The term “visualization data” refers to structured data prepared for rendering by a display system, including elements such as lists, tables, graphical values, coordinates, labels, and annotations, which support visual presentation of analysis results.

The term “list information” refers to structured representations of multiple data items, such as records, events, or objects, arranged in an ordered or indexed form suitable for tabular or textual display.

The term “statistical information” refers to numerical summaries derived from data, such as counts, averages, variances, distributions, or other aggregated measures.

The term “graph information” refers to data describing points, lines, bars, or other graphical elements that can be rendered as charts or plots, including time-series graphs, histograms, and bar charts.

The term “region-highlighting information” refers to data that specifies positions, shapes, or extents of regions of interest in an image, such as coordinates of bounding boxes, masks, or overlays used to emphasize particular image areas.

The term “annotation information” refers to textual or symbolic labels, markers, or descriptors associated with specific data items or regions, such as labels for detected objects or tags for noteworthy data points.

The term “metadata” refers to descriptive information about data or processing, including but not limited to data type, schema, timestamps, model configuration, confidence scores, and processing parameters.

The term “information-protection processing” refers to computational operations and control measures that maintain confidentiality, integrity, and availability of data and analysis results, including authentication, authorization, encryption, and logging.

The term “prevention of unauthorized access” refers to mechanisms and procedures that restrict data access to authorized entities by verifying identities and enforcing access policies.

The term “encryption” refers to a transformation that converts data into a coded form using a cryptographic algorithm and key, such that the original data is recoverable only by entities possessing appropriate decryption capabilities.

The term “access control” refers to a policy and mechanism for regulating which users, processes, or devices may read, write, modify, or otherwise interact with specific data or resources.

The term “real time” refers to a mode of operation in which data processing and result transmission are performed with latency low enough that the user can perceive the system as responding promptly to inputs, without substantial delay relative to interactive use.

The term “industrial field” refers to a domain of economic or technical activity, such as a business sector, technical sector, or application area, characterized by specific data types, attributes, and evaluation indices.

The term “domain-specialized model” refers to a data-analysis model or explanation-generation model whose configuration or parameters are adapted to properties, constraints, or objectives of a particular industrial field.

In one embodiment, a server executes a set of programs to implement a prompt-driven data analysis and explanation system. The server comprises at least one processor, a main memory, a non-transitory storage device, and a network interface connected to one or more terminals via a communication network. The server executes an operating system such as a general-purpose server operating system and runs application processes implemented, for example, in a high-level programming language. The server uses a parallel computation device such as a graphics processing unit and associated driver software to accelerate machine learning computations.

The server stores program modules including a data ingestion module, a preprocessing module, a task-interpretation module, a machine learning inference module, a generative AI module, a visualization module, and a security module. The server stores these modules and related configuration data in the storage device and loads them into the main memory for execution by the processor.

The terminal is an information processing device such as a personal computer, a tablet, or a smartphone. The terminal runs a web browser or a dedicated application that communicates with the server over a secure protocol. The terminal presents upload controls, text input fields for a prompt sentence, and result views such as tables, charts, and images. The user operates the terminal to upload data sets, to provide prompt sentences in natural language, and to inspect analysis results and explanation outputs.

The server uses specific software components to implement data ingestion and preprocessing. For example, the server employs a data processing library to read tabular data into a table-like data structure and an image processing library to read image data into a multi-dimensional numeric array. The server stores uploaded raw data in a storage device, such as a relational data storage system, a file system, or an object storage system, and maintains metadata including file type, schema information, and upload time in a structured index.

The server processes tabular data using operations such as missing-value completion, normalization, and encoding. The server calculates, for each column, a statistic such as mean or median and replaces missing entries with the calculated statistic. The server applies normalization, for example, by subtracting the column mean and dividing by the column standard deviation, to transform feature values into a standardized distribution. The server encodes categorical columns using a scheme such as one-hot encoding or ordinal encoding, producing a dense or sparse numeric feature representation. The server thereby converts heterogeneous raw tabular data into a consistent numeric feature matrix suitable for machine learning computations.

The server processes image data using operations such as size conversion, pixel-value normalization, and color-space conversion. The server resizes each image to a predetermined resolution, for example, 640 by 640 pixels, to ensure a fixed input dimension for downstream neural networks. The server converts images from one channel ordering or color space to another, for example, from one three-channel representation to another three-channel representation expected by the model. The server normalizes pixel values by scaling them to a continuous range or by subtracting a channel-wise mean and dividing by a channel-wise standard deviation. The server optionally applies data augmentation operations, such as random horizontal flipping, rotation, or cropping, when training models. These operations transform raw images into tensors with consistent dimensionality and numerical ranges.

The server uses a machine learning inference module that implements neural network architectures tailored to the data type. For tabular data, the server may use a feed-forward neural network comprising an input layer, multiple fully connected hidden layers with non-linear activation functions, and an output layer suited to a prediction or anomaly-detection task. The server may alternatively use a transformer-based architecture for tabular data, in which self-attention layers compute relationships across features and records. For image data, the server may use a convolutional neural network or a transformer-based vision model with convolutional or attention layers, feature pyramids, and detection heads that output class scores and bounding boxes.

The server configures the neural networks with trainable parameters including weight matrices and bias vectors. The server trains these models using labeled data stored in the storage device. During training, the server computes a loss function such as cross-entropy loss for classification, mean squared error for regression, or a combination of localization and classification losses for object detection. The server calculates gradients of the loss with respect to the model parameters using automatic differentiation implemented in a machine learning framework. The server updates the parameters using an optimization algorithm such as stochastic gradient descent or an adaptive gradient method. The server optionally applies regularization techniques such as weight decay or dropout to improve generalization.

The server deploys trained models for inference. During inference, the server transfers preprocessed feature tensors to the parallel computation device. The parallel computation device executes matrix multiplications, convolution operations, and activation functions in parallel, thereby accelerating computation compared to a standard central processing unit. The server receives output tensors representing probabilities, scores, or feature embeddings and converts these tensors into structured analysis results, such as class labels, anomaly scores, or bounding box coordinates.

The server uses a task-interpretation module to process a prompt sentence in natural language. The user enters a prompt sentence via the terminal, such as:
“Please detect any anomalies in this dataset and explain which features contributed most to each anomaly.”
or
“From these images, identify the types of animals present and provide a count of each animal type.”
or
“Using this dataset, please forecast the demand for the next three months and describe the main trends and seasonal patterns.”

The terminal sends the prompt sentence and an identifier of the associated data set to the server. The server passes the prompt sentence to a language-understanding model. In one embodiment, the server implements a generative AI model based on a transformer architecture. The transformer model comprises an embedding layer, multiple self-attention layers, feed-forward sublayers, and a final projection layer over a vocabulary. The server tokenizes the prompt sentence into tokens, maps tokens to embeddings, and computes contextual representations through layers of multi-head self-attention and non-linear transformations.

The server configures the transformer-based generative AI model as a classifier or planner for task interpretation by training or fine-tuning the model on pairs of natural-language prompts and structured task descriptions. The structured task descriptions include fields such as task type (for example, classification, anomaly detection, forecasting, or object detection), target attributes or columns, and output preferences. During training, the server defines a loss function that penalizes deviations between predicted structured descriptions and target descriptions and updates model parameters accordingly.

During deployment, the server uses the generative AI model to generate a structured representation of the prompt sentence. The server may define an output format such as a token sequence encoding key-value pairs, where particular tokens designate a task type, attribute list, or output format. The server parses the generated sequence to extract a task type indicator, a list of feature names or image categories to focus on, and a description of desired outputs such as explanations or graphical summaries. This task-interpretation processing is executed automatically and repeatedly for new prompt sentences.

The server uses the output of the task-interpretation module to configure the analysis pipeline. For example, when the task type is anomaly detection on tabular data, the server selects a pre-trained anomaly detection model such as an autoencoder or an isolation-based method; when the task type is object detection on images, the server selects a pre-trained detection network and configures its class list to match categories inferred from the prompt sentence. The server may also adjust thresholds, time ranges, or subsets of features based on the interpreted attributes. This dynamic configuration reduces manual intervention and allows the server to route different requests to different internal models and algorithms.

The server employs a generative AI module to generate natural-language explanation information. The server uses the same or a different transformer-based generative AI model as a text generator. The server constructs an input sequence that concatenates a representation of the prompt sentence, a representation of key analysis results (for example, a compressed summary of anomalous records, detected objects, or forecast values), and metadata such as confidence scores, feature importances, or time ranges. The server encodes these inputs and generates a textual explanation that includes a summary of the results, a rationale for why certain items are considered anomalous or important, and commentary relating to trends or patterns.

In one example, when the user issues the prompt sentence “Please detect any anomalies in this dataset and explain which features contributed most to each anomaly,” the server runs an anomaly detection model on the preprocessed tabular data, obtains anomaly scores, and identifies top contributing features for each anomalous record using techniques such as gradient-based attribution or feature perturbation. The server then inputs a representation of these features and scores into the generative AI model, which produces text such as:

“Transaction A is anomalous because the amount is more than three standard deviations above the typical range for this customer segment, and the transaction time occurs at an unusual hour compared to historical behavior.” The server sends this explanation text to the terminal for display.

In another example, when the user issues the prompt sentence “From these images, identify the types of animals present and provide a count of each animal type,” the server runs the object detection model on each preprocessed image, generates bounding boxes and class labels for detected animals, aggregates counts per class, and passes a representation of these counts and example detections to the generative AI model. The generative AI model produces text such as: “Across all images, the system detected 25 instances of dogs, 10 instances of cats, and 5 instances of birds. Dogs are primarily located in the central region of the images, while cats appear near the edges.” The server also overlays bounding boxes and labels on the images and sends both the annotated images and the textual summary to the terminal.

In another example, when the user issues the prompt sentence “Using this dataset, please forecast the demand for the next three months and describe the main trends and seasonal patterns,” the server uses a time-series forecasting model such as a recurrent neural network or a transformer-based sequence model. The server constructs input sequences representing historical demand values and possible covariates, and the model generates predicted values for future time steps. The server computes error metrics using hold-out data during training and selects hyperparameters that minimize forecast error. At inference time, the server runs the model on recent data, generates forecast values, and passes the results to the generative AI model, which produces text describing peaks, troughs, and seasonal fluctuations.

The server implements a visualization module that converts analysis results and explanation information into visualization data that can be efficiently transmitted and rendered by the terminal. For tabular data, the server produces list information, statistical summaries, and data points for charts, such as time-series plots or histograms. For image data, the server produces annotated images with region-highlighting information, where bounding boxes or masks are drawn using the detection results, and annotation information such as labels and confidence scores is placed near the highlighted regions. The server arranges these elements into a structured response and transmits them to the terminal over the network.

The server implements a security module that performs information-protection processing. The server uses secure transport protocols to encrypt communication between the server and the terminal. The server enforces authentication and access control policies to ensure that only authorized users can upload data, execute analyses, and view results. The server records access logs and applies encryption to stored data when necessary. These measures maintain confidentiality and integrity of the data and the analysis results.

The server improves computer technology by dynamically configuring and executing data-type-specific pipelines, by offloading parallelizable computations to specialized hardware, and by compressing complex, multi-stage analysis results into human-readable explanations generated by a transformer-based model. The dynamic task-interpretation mechanism allows the processor to tailor model selection, feature selection, and output formatting on a per-request basis without requiring static code paths for each scenario. This reduces unnecessary data transfers and re-computations, thereby lowering latency and improving throughput.

By performing preprocessing steps that are aligned with model architectures and parallel computation capabilities, the server reduces the dimensionality and variability of input data before it is transferred to the parallel computation device, resulting in more efficient memory usage and faster computation. For example, resizing images to a fixed resolution and normalizing pixel values allows convolutional and attention layers to operate on regular tensors with better cache locality, thus lowering computation time.

By using generative AI models that are trained not only to produce generic text but to consume structured analysis outputs and metadata, the server offloads the interpretation of high-dimensional numerical results from the user to the machine. The generative AI model applies learned relationships between result patterns and explanation templates that are not easily replicable by rule-based systems. The server thereby reduces user cognitive load and eliminates manual steps that would be impracticable at scale, such as manually inspecting thousands of anomaly scores or bounding boxes.

The server achieves improved accuracy and robustness in analysis tasks by using neural network architectures that exploit interactions among features and among data instances. For example, the server uses self-attention mechanisms in transformer layers to capture long-range dependencies in time-series data or to attend to relevant regions in images. The server uses loss functions and regularization schemes that improve generalization and reduces overfitting, resulting in more reliable anomaly detection and forecasting compared to simple threshold-based or rule-based methods.

The server further enables domain specialization by training or fine-tuning domain-specific models when prompts or configuration information indicate a particular industrial field. The server may maintain separate model instances or parameter adapters for different domains, such as manufacturing, finance, or healthcare, and select or activate them based on the task-interpretation results. The server thereby allows the same software framework and hardware resources to be reused across domains while adapting internal parameters and structures for domain-specific data distributions and evaluation metrics.

In alternative embodiments, the server may implement different preprocessing schemes, neural network architectures, loss functions, and optimization algorithms while maintaining the core idea of prompt-driven dynamic configuration and generative explanation. For instance, the server may use graph neural networks for relational data, recurrent neural networks for certain sequential patterns, or hybrid architectures that combine convolutional and attention layers. The server may adjust the size and depth of models according to resource constraints, using smaller models for low-latency applications and larger models for offline or batch analysis.

The terminal may be realized as a thin client where most processing is performed by the server, or as a richer client that performs additional local preprocessing or caching to reduce network bandwidth. The user may interact with the system using a web interface, a command-line interface, or an application-specific user interface, but in each case the server receives data, receives a prompt sentence, and returns structured results and explanation information.

By integrating these components and operations into a unified system, the server enables a form of computation that goes beyond simple automation of manual tasks. The server adapts its internal computational graph to changing user intents expressed in natural language, optimizes data flows and hardware usage, and generates explanations in real time based on internal states that are not accessible in traditional manual workflows. This architecture produces concrete technical effects including reduced processing latency, increased analysis accuracy, improved resource utilization, and enhanced data management within a computing environment.

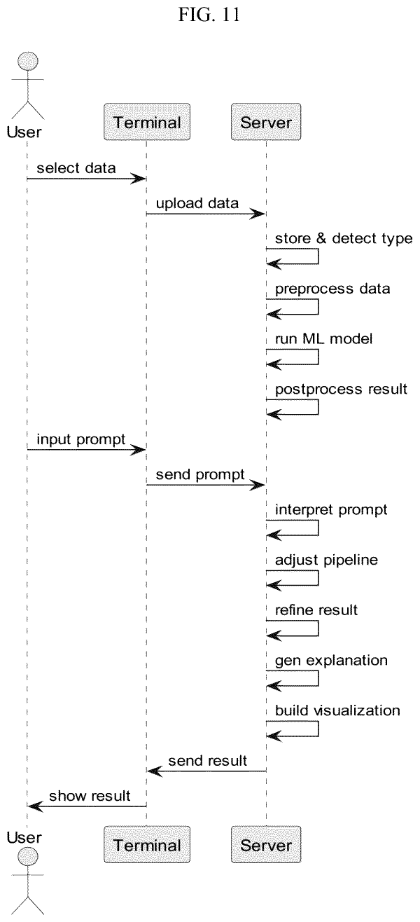

The following describes the processing flow using FIG. 11.

### Step 1

The user operates the terminal and selects input data.

The user chooses one or more data files stored on the terminal, such as a CSV file, an image file, or a compressed archive of multiple files. The terminal reads the selected file metadata (file name, size, type) via an operating system file dialog.

Input: raw data files stored on the terminal.

Output: an internal representation on the terminal side that includes file handles and metadata prepared for upload.

### Step 2

The terminal transmits the selected data to the server.

The terminal encapsulates the raw data files in a network request, for example, an HTTP POST request with a multipart payload, and sends the request to an upload endpoint of the server over a secure communication channel.

Input: file handles and metadata from Step 1.

Output: a network payload containing the raw data, which is delivered to the server.

### Step 3

The server receives and stores the uploaded data.

The server accepts the network request via a network interface, parses the multipart payload, and writes each uploaded file to a storage device such as a file system or object storage. The server records metadata (file path, size, type, upload time, user identifier) in an internal index structure.

Input: network payload containing raw data from Step 2.

Output: stored raw data files and associated metadata entries in the server's storage device.

### Step 4

The server determines the data type and loads the data into memory.

The server inspects file extensions, content headers, and possibly a portion of file contents to classify each file as tabular data, image data, or another supported type. The server then loads the file into an in-memory structure: for tabular data, the server constructs a table-like data structure with rows and columns; for image data, the server constructs a multi-dimensional numeric array representing pixel values.

Input: stored raw data files and metadata from Step 3.

Output: in-memory data structures representing the raw tabular data or image data, along with an assigned data type label.

### Step 5

The server preprocesses tabular data.

When the data type is tabular, the server scans each column to detect missing values, data type inconsistencies, and out-of-range values. The server replaces missing numeric values with computed statistics such as means or medians, normalizes numeric columns by transforming them to a standardized range or distribution, and encodes categorical columns into numeric feature vectors. The server may also drop columns that are constant or irrelevant based on predefined rules.

Input: raw tabular data structure from Step 4.

Output: a normalized numeric feature matrix suitable for machine learning, along with a mapping from original columns to feature indices.

### Step 6

### The Server Preprocesses Image Data.

When the data type is image, the server resizes each image to a fixed resolution, converts color channels to a consistent color space, and normalizes pixel values to a standardized numeric range. The server optionally applies augmentation operations such as flipping or cropping if the data is intended for model training. The server converts the processed images into tensor structures compatible with a parallel computation device.

Input: raw image arrays from Step 4.

Output: preprocessed image tensors with fixed dimensions and normalized pixel values.

### Step 7

The server transfers preprocessed data to a parallel computation device.

The server allocates memory on a parallel computation device and copies the preprocessed feature matrices or image tensors from main memory to device memory. The server arranges the data into batches to exploit parallel processing capabilities.

Input: preprocessed tabular feature matrix from Step 5 and/or preprocessed image tensors from Step 6.

Output: batched data stored in device memory, ready for model inference.

### Step 8

The server executes a machine learning model on the preprocessed data.

The server invokes a trained machine learning model, such as a neural network, on the parallel computation device. The server performs forward propagation by multiplying input tensors with weight matrices, applying activation functions, and propagating through network layers. For tabular data, the server computes outputs such as predicted scores or anomaly scores; for image data, the server computes outputs such as class probabilities and bounding box coordinates.

Input: batched data in device memory from Step 7 and model parameters stored in device memory or main memory.

Output: raw model outputs, including prediction scores, class labels, anomaly scores, or detection results, returned to main memory as structured tensors.

### Step 9

The server post-processes the model outputs into analysis results.

The server converts raw model outputs into interpretable analysis results. For classification, the server selects the class with maximum probability per instance; for anomaly detection, the server applies a threshold to anomaly scores to label instances as normal or anomalous; for object detection, the server filters bounding boxes using a confidence threshold and applies non-maximum suppression to remove redundant detections. The server attaches identifiers, timestamps, and other metadata to each analysis result.

Input: raw model output tensors from Step 8.

Output: structured analysis results, such as labeled records, lists of anomalous instances, or sets of detected objects with associated scores and coordinates.

### Step 10

The user inputs a prompt sentence via the terminal.

The user views an input field on the terminal and enters a natural-language instruction describing the desired analysis or explanation. Examples include:
“Please detect any anomalies in this dataset and explain which features contributed most to each anomaly.”
“From these images, identify the types of animals present and provide a count of each animal type.”
“Using this dataset, please forecast the demand for the next three months and describe the main trends and seasonal patterns.”

The terminal captures the text from the input field and packages it for transmission to the server, together with identifiers for the relevant data set or analysis run.

Input: user-typed natural-language text.

Output: a prompt payload containing the prompt sentence and associated identifiers, ready to be sent to the server.

### Step 11

The terminal sends the prompt sentence to the server.

The terminal generates a network request, such as an HTTP POST with a structured body, containing the prompt sentence and references to the stored data or prior analysis results. The terminal transmits this request to the server over the secure communication channel.

Input: prompt payload from Step 10.

Output: a network message delivered to the server that carries the prompt sentence and context information.

### Step 12

The server interprets the prompt sentence using a generative AI model.

The server receives the prompt payload, extracts the prompt sentence, and tokenizes the sentence into tokens. The server feeds the token sequence into a generative AI model based on a transformer architecture. The model computes contextual embeddings via attention mechanisms and generates a sequence that encodes a structured task description, including at least a task type, relevant attributes, and desired output format. The server decodes this sequence to obtain explicit task parameters, such as whether to perform anomaly detection, object detection, or forecasting, and which features or classes to emphasize.

Input: prompt sentence and associated identifiers from Step 11.

Output: a structured task description specifying task type, target attributes, and output preferences.

### Step 13

The server configures the analysis pipeline based on the interpreted task.

The server reads the structured task description and selects appropriate models, thresholds, and submodules. For example, if the task is anomaly detection focused on certain features, the server restricts the feature set to the specified attributes and selects an anomaly detection algorithm; if the task is object detection for specific categories, the server adjusts the list of classes and confidence thresholds. The server updates internal configuration structures that control which preprocessing outputs and which models will be used in subsequent computations.

Input: structured task description from Step 12 and available model inventory.

Output: a configured analysis pipeline specification that maps inputs to specific models and processing steps.

### Step 14

The server reuses or reruns analysis based on the configured pipeline.

Depending on whether prior analysis results are available, the server either reuses existing analysis results or reruns the machine learning model with adjusted parameters or additional constraints. For example, the server may filter previously computed anomaly scores according to a new threshold or recompute object detections with a different class set. The server ensures that the configured pipeline's requirements are satisfied, possibly invoking additional computations such as feature attribution or temporal aggregation.

Input: configured pipeline specification from Step 13 and existing preprocessed data and/or analysis results.

Output: refined or newly computed analysis results tailored to the interpreted task.

### Step 15

The server prepares input for the generative AI model to generate explanations.

The server constructs a composite representation that includes the prompt sentence, the key analysis results, and relevant metadata such as feature importances, anomaly scores, object counts, or forecast statistics. The server serializes these elements into a structured format and converts them into token sequences suitable for the generative AI model.

Input: prompt sentence from Step 11 and task-specific analysis results from Step 14.

Output: a formatted input sequence for the generative AI model that encodes both the user request and the computed results.

### Step 16

The server generates natural-language explanation information using the generative AI model.

The server feeds the formatted input sequence into the generative AI model. The model processes the input through multiple attention layers and generates an output token sequence that forms explanatory text. The server decodes the token sequence into human-readable sentences, which may include a summary of the results, reasons for particular classifications or anomaly flags, and commentary on trends or patterns.

Input: formatted input sequence from Step 15.

Output: natural-language explanation text describing and interpreting the analysis results.

### Step 17

The server constructs visualization data for the terminal.

The server combines the structured analysis results and the generated explanation text into visualization-ready structures. For tabular data, the server builds list entries and statistical summaries and computes data series for charts. For image data, the server overlays bounding boxes and labels on original images, encodes the annotated images, and associates them with captions derived from the explanation text. The server organizes these elements into a response structure optimized for rendering on the terminal.

Input: structured analysis results from Step 14 and explanation text from Step 16.

Output: visualization data including tables, chart data, annotated images, and textual explanations.

### Step 18

The server sends the visualization data to the terminal.

The server serializes the visualization data into a response message and transmits it to the terminal via the network interface. The server ensures that binary resources such as annotated images and structured data such as chart series are included or referenced in the response.

Input: visualization data from Step 17.

Output: a response payload delivered to the terminal, containing all information necessary for display.

### Step 19

The terminal renders the analysis results and explanations for the user.

The terminal receives the response payload, parses the visualization data, and updates its user interface components. The terminal displays tables of results, renders charts using local graphics capabilities, and shows annotated images with highlighted regions and labels. The terminal also presents the natural-language explanation text in a readable format, such as a paragraph or bullet points.

Input: response payload from Step 18.

Output: a rendered user interface that presents analysis results, explanations, and visualizations to the user.

### Step 20

The user reviews the results and optionally issues additional prompt sentences.

The user inspects the displayed information, understands the system's findings and explanations, and may decide to refine the analysis by entering new prompt sentences that impose further constraints or request alternative views. The terminal captures any new prompt sentences and repeats the interaction with the server, thereby enabling iterative, prompt-driven refinement of the analysis.

Input: rendered interface from Step 19 and user's interpretation of the results.

Output: optional new prompt sentences and interaction requests that trigger subsequent processing cycles.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional inventory management systems that rely on computerized data processing typically separate numerical prediction logic from user-facing decision support, and treat both as independent layers. In many cases, a server collects inventory data, executes a forecasting algorithm, and simply exposes raw or lightly summarized prediction values to a user interface. Such systems suffer from several technical problems.

First, conventional systems generally handle inventory time-series data and prediction outputs as opaque application-level objects without a standardized internal representation optimized for downstream analysis and explanation. As a result, numerical prediction results must be repeatedly transformed or duplicated across different software components, increasing processing overhead, memory consumption, and latency in generating actionable outputs.

Second, existing systems that employ machine learning models for demand or inventory forecasting usually produce only scalar or vector prediction results, and do not natively generate structured, machine-readable analysis artifacts that capture, in a unified schema, risk determinations such as shortage risk and excess risk, predicted occurrence times, and recommended replenishment or reduction quantities. Consequently, additional ad hoc logic is required to compute and annotate such risk indicators, which often leads to inefficient, non-reusable code paths and inconsistent behavior across system modules.

Third, even when prediction results and risk indicators are computed, conventional systems typically present such information as static dashboards that are difficult for users to interpret in complex operational contexts. To provide more intelligible explanations, some systems may incorporate generic text generation utilities; however, these utilities are not tightly coupled with the internal analysis pipeline and do not systematically consume the full set of structured prediction outputs as context. This loose coupling results in generic or incomplete natural-language explanations and requires substantial manual configuration or scripting to adapt to different use cases.

Fourth, known systems that integrate generative models for natural-language interaction generally treat such models as external tools to which unstructured prompts are sent. The prompts are manually crafted, and the underlying system state, including real-time inventory and forecast data, is not programmatically incorporated into the prompt in a consistent and automated manner. This leads to increased cognitive load on users, redundant data transfers, and variability in output quality, and it prevents the generative model from fully leveraging the system's internal analytical context.

Fifth, existing architectures often lack a unified mechanism for dynamically combining user-specified prompt sentences with system-generated instructions and structured analytical context, in a way that is programmatically controlled and repeatable. This deficiency makes it difficult to build stable, low-latency workflows where a server can automatically integrate user intent, current time-series data, prediction model outputs, and risk evaluation results into a single compound prompt, send it to a generative model, and feed the resulting explanation back into a real-time display pipeline.

Accordingly, there is a need for an improved computer-implemented system that (i) normalizes and stores inventory time-series data in a form optimized for predictive analysis, (ii) trains and executes a prediction model to produce not only future inventory values but also derived, structured analysis result data, (iii) programmatically constructs context-rich prompts that combine such structured analysis result data with user-specified or system-generated instruction sentences, (iv) supplies the combined prompts to a generative information processing model to obtain natural-language descriptions and recommendations, and (v) drives an information display device based on both structured analytical outputs and generated natural-language content. Such a system should reduce processing redundancy, improve integration between numerical prediction and natural-language generation, and enhance the technical efficiency and responsiveness of server-side inventory management and decision-support operations.

The specific processing by the specific processing unit 290 of the data processing device 12 in Application Example 1 is realized by the following means.

The present invention provides a server comprising a processor configured to acquire time-series data indicative of inventory states of articles from a plurality of information sources, convert records representing the inventory states into a standardized internal format, and store the records in a storage device for accumulation; to use historical time-series data relating to past inventory states stored in the storage device to train a regression-type numerical prediction model, to input current time-series data relating to inventory states into the prediction model, to numerically predict future inventory transitions over a predetermined period, and to extract target items that are likely to experience inventory shortage or inventory excess by comparing prediction results with a safety inventory level and a storage capacity level; to generate, for each of the extracted target items, structured analysis result data including at least a predicted occurrence time of the inventory shortage or the inventory excess, a predicted minimum or maximum inventory quantity, a determination result of the inventory shortage risk or the inventory excess risk, and a recommended quantity for replenishment or reduction, based on the predicted future inventory transitions and predetermined reference values; to receive a prompt sentence input by a user via an input reception function, to automatically generate an instruction sentence based on at least the time-series data relating to inventory states and the prediction results, and to generate a compound prompt sentence by combining the prompt sentence input by the user with the automatically generated instruction sentence; to input the compound prompt sentence to a generative information processing model while appending the structured analysis result data as context information, and to cause the generative information processing model to execute a generation process of a description or recommendation in natural language relating to inventory management; and to transmit response data including the description or recommendation in natural language output from the generative information processing model and the structured analysis result data to an information display device via a communication interface, and to generate display control information for causing the information display device to visually display at least an inventory state, a future inventory transition, an inventory risk, and the description or recommendation in natural language included in the response data. This enables tighter integration between numerical prediction and generative natural-language processing in a server-centric architecture, reduces redundant data transformations by using standardized structured analysis result data as shared context, improves computational efficiency and responsiveness when generating explanations and recommendations, and provides a technically improved mechanism for dynamically combining user intent, system-generated instructions, and real-time analytical context into prompts that drive a generative information processing model, thereby enhancing the overall performance and usability of computer-implemented inventory management.

The term “system” refers to a combination of hardware and software components, including at least one processor and one or more storage and communication elements, that cooperate to execute the functions described in the claims.

The term “processor” refers to one or more hardware processing units, such as a central processing unit or an accelerator, configured to execute instructions for performing data acquisition, storage, prediction, analysis, prompt generation, model invocation, and display control operations.

The term “time-series data” refers to data records in which each record is associated with at least one timestamp and one or more values, such as inventory quantities, that change over time.

The term “inventory state” refers to information indicating a quantity or condition of at least one managed item at a given time, including but not limited to available quantity, reserved quantity, or storage location.

The term “articles” refers to physical items or goods whose quantities are monitored and managed by the system.

The term “information sources” refers to hardware or software components that provide data to the system, such as sensors, terminals, application programs, or external data services.

The term “record” refers to a unit of data including one or more fields, such as an identifier, a timestamp, and a quantity value, that collectively represent a single observation of an inventory state.

The term “standardized internal format” refers to a data representation or schema defined within the system so that inventory-related records from heterogeneous sources are normalized into a consistent structure suitable for processing.

The term “storage device” refers to any non-transitory computer-readable medium, such as a memory device or a disk device, configured to store data, models, and configuration information.

The term “regression-type numerical prediction model” refers to a mathematical or machine learning model that receives numerical input values and outputs predicted numerical values, such as future inventory quantities, expressed as continuous quantities.

The term “prediction model” refers to a trained computational model that, based on historical and current input data, outputs predicted values representing future states of inventory.

The term “future inventory transitions” refers to predicted changes of inventory states over a future time interval, typically represented as a sequence of predicted inventory quantities with associated timestamps.

The term “predetermined period” refers to a fixed or configurable time horizon in the future, such as several hours or days, over which the prediction model outputs predicted inventory states.

The term “safety inventory level” refers to a threshold quantity that represents a minimum acceptable inventory level below which there is considered to be a shortage risk.

The term “storage capacity level” refers to a threshold quantity that represents a maximum acceptable inventory level above which there is considered to be an excess or overstock risk.

The term “target items” refers to items selected from among all managed articles for which the prediction model or subsequent analysis determines that an inventory shortage or inventory excess is likely to occur.

The term “inventory shortage” refers to a condition in which a predicted or actual inventory quantity for an item falls below a safety inventory level.

The term “inventory excess” refers to a condition in which a predicted or actual inventory quantity for an item exceeds a storage capacity level.

The term “prediction results” refers to output values generated by the prediction model, including predicted inventory quantities and any derived measures computed from these quantities.

The term “structured analysis result data” refers to machine-readable data organized according to a predefined schema, including fields such as risk type, predicted occurrence time, predicted minimum or maximum inventory quantity, and a recommended replenishment or reduction quantity.

The term “predicted occurrence time” refers to a time value or time range at which an inventory shortage or inventory excess is predicted to occur according to the prediction results.

The term “predicted minimum inventory quantity” refers to a lowest predicted inventory quantity for an item during the predetermined period as output or derived from the prediction model.

The term “predicted maximum inventory quantity” refers to a highest predicted inventory quantity for an item during the predetermined period as output or derived from the prediction model.

The term “recommended quantity for replenishment or reduction” refers to a computed value indicating how much inventory of a given item should be increased or decreased to maintain the inventory within desired thresholds.

The term “determination result” refers to data indicating an outcome of a comparison or evaluation, such as whether a shortage risk or an excess risk is present for an item.

The term “inventory shortage risk” refers to a likelihood or risk state that an inventory quantity will drop below the safety inventory level within the predetermined period.

The term “inventory excess risk” refers to a likelihood or risk state that an inventory quantity will exceed the storage capacity level within the predetermined period.

The term “prompt sentence” refers to a text string that provides instructions, questions, or context to a generative information processing model for the purpose of controlling its output.

The term “instruction sentence” refers to a text string automatically generated by the system that specifies how the generative information processing model should interpret or use the associated context data.

The term “compound prompt sentence” refers to a combined text string that includes both a user-input prompt sentence and at least one system-generated instruction sentence.

The term “context information” refers to data supplied to a generative information processing model in addition to a prompt sentence, such as structured analysis result data or configuration parameters, to guide the generation process.

The term “generative information processing model” refers to a model configured to generate output data, such as natural-language text, by processing a prompt sentence and associated context information.

The term “description or recommendation in natural language” refers to text output produced by the generative information processing model in a human-readable language, explaining system results or suggesting actions.

The term “input reception function” refers to a software or hardware function that accepts input data from a user or another system component, including prompt sentences and parameter values.

The term “response data” refers to data transmitted from the server to an information display device, including at least generated natural-language text and structured analysis result data.

The term “information display device” refers to an apparatus having a display unit and an interface capable of receiving data from the server and visually presenting that data to a user.

The term “communication interface” refers to hardware and software components that enable data exchange between the server and external devices over a communication network.

The term “display control information” refers to data or commands that specify how content, such as inventory states, predictions, risks, and natural-language text, should be rendered or arranged on an information display device.

The term “inventory risk” refers to a general risk category associated with inventory states, including at least inventory shortage risk and inventory excess risk.

The term “user” refers to a human operator or entity that interacts with the system, such as by providing prompt sentences, reviewing outputs, and making operational decisions.

In one embodiment, a server implements the claimed system using at least one processor, a main memory, a non-transitory storage device, and a network interface operating under a general-purpose operating system such as a server-class operating system. The server executes application software including a data acquisition module, a data normalization module, a prediction module, an analysis module, a generative AI interface module, and a display control module. The server is connected via a communication network to one or more terminals, which operate as information display devices.

The server acquires inventory-related time-series data from multiple information sources. The server uses a network interface to receive messages from inventory sensors, warehouse control systems, and enterprise resource planning systems. The server receives records that include at least a product identifier, a timestamp, a quantity value, and a location identifier. The server converts the received records into a standardized internal format, for example into rows of a relational table stored in a database management system such as a relational database, and into in-memory structures such as arrays or tabular data structures provided by a data-processing library.

The server normalizes units and encodings during this conversion. The server converts all quantity values into a base unit, for example pieces, and maps different source identifiers into unified product keys and location keys using lookup tables stored in the same database. The server assigns each record a normalized timestamp, for example by converting local times into a standard coordinated time. The server stores the normalized records in a time-series table partitioned by product identifier and time interval. This specific data layout allows the server to retrieve contiguous sequences of inventory quantities per product efficiently, which reduces disk I/O and improves the throughput of subsequent prediction computations.

The server uses the stored historical time-series data to train a regression-type numerical prediction model implementing a neural network architecture. In one embodiment, the server uses a deep learning framework such as TensorFlow running on a processor and optionally an accelerator such as a general-purpose graphics processing unit. The server constructs, in memory, a neural network that includes an input layer sized to receive a fixed-length sequence of inventory quantities and optional auxiliary features (for example recent shipment counts and day-of-week indicators), one or more recurrent layers such as long short-term memory (LSTM) layers, and one or more fully connected output layers that output predicted inventory quantities over a future horizon.

The server preprocesses the time-series data before training. The server resamples the historical data to a fixed interval, such as every hour, and fills missing intervals using interpolation or forward filling. The server then computes feature vectors for each time step, including normalized inventory quantities, differences between successive time steps, and binary indicators for special periods such as weekends or holidays. The server scales numerical values to a standard range using a scaling procedure such as min-max scaling or standardization. The server partitions the data into training, validation, and test sets.

The server defines a loss function such as mean squared error between the predicted inventory quantities and the actual inventory quantities. The server initializes the weights of the neural network randomly or using a predefined initialization strategy. The server then performs iterative training using an optimization algorithm such as stochastic gradient descent or a variant such as Adam. The server computes gradients of the loss with respect to network weights using backpropagation through time for the recurrent layers, and updates the weights on each iteration. The server monitors validation loss to implement early stopping and to prevent overfitting. This training process yields a set of model parameters stored on the storage device as a model file.

The server periodically retrains or fine-tunes the model when additional historical data becomes available. The server can update only part of the model, such as the last layers, to adapt to recent changes in demand patterns while preserving the learned representation of longer-term dynamics. The server records model versions with associated metadata such as training data range, hyperparameters, and performance metrics, and selects the best-performing version for inference.

The server uses the trained prediction model to generate future inventory transitions. The server loads the latest model version into memory and fetches, from the time-series table, the most recent sequence of inventory states for each product over a fixed look-back window. The server applies the same preprocessing pipeline as used during training, including resampling, feature computation, and scaling. The server then passes the resulting tensors to the prediction model, which computes predicted inventory quantities for future time steps over a predetermined period, such as the next 24 hours.

The server analyzes the prediction results to derive structured analysis result data. The server calculates, for each product, the minimum predicted inventory quantity and the maximum predicted inventory quantity over the prediction horizon. The server compares the predicted quantities with threshold values stored in a configuration table, including a safety inventory level and a storage capacity level. The server determines that an inventory shortage risk exists if the predicted quantity is expected to fall below the safety inventory level at any future time step, and determines that an inventory excess risk exists if the predicted quantity is expected to exceed the storage capacity level at any future time step. The server computes a predicted occurrence time for each risk case by identifying the earliest time step at which the threshold is crossed.

The server computes a recommended replenishment quantity or reduction quantity based on a target level. For example, the server calculates the difference between a target inventory level and the predicted minimum inventory quantity to obtain a recommended replenishment quantity, or the difference between the predicted maximum inventory quantity and a target upper inventory level to obtain a recommended reduction quantity. The server encodes, for each product that satisfies a risk condition, a structured record including at least the product identifier, the predicted minimum or maximum quantity, the predicted occurrence time, the type of risk, and the recommended quantity.

The server aggregates these records into structured analysis result data, for example as a table in memory or as serialized objects. The server uses an internal schema that assigns each field a fixed data type, such as integer, floating-point, or timestamp. This explicit structure enables the server to reuse the same data both for direct display, for downstream optimization modules, and as context for the generative AI model. Because the analysis results are structured, the server does not need to compute the same thresholds or risk determinations multiple times; this reduces redundant computation and improves response time.

The server provides an interface for a generative AI model. In one embodiment, the server accesses a generative AI model over a network, for example via an application programming interface, or runs a generative language model locally using a model execution library. The generative AI model receives a prompt sentence and optional context information and produces a natural-language output. The server does not rely on generic free-form prompts only. Instead, the server constructs compound prompt sentences that combine user input with system-generated instructions and systematically incorporates structured analysis result data into the context.

The server receives a prompt sentence from a user via a terminal. The user operates the terminal, which runs an application that sends the user's text input to the server. The server can also generate an instruction sentence automatically, such as “Explain the inventory risks and recommended actions for the following items over the next 24 hours in concise terms suitable for an operations manager.” The server then combines the user's prompt sentence and the instruction sentence into a compound prompt sentence.

By way of example, the user can enter a prompt sentence such as:
“Based on the current inventory forecasts, explain which products are at highest risk of shortage in the next 24 hours and how I should prioritize replenishment.”

In another example, the user can input a prompt sentence such as:
“Explain in simple terms why Product B and Product C are predicted to run out of stock tomorrow, and suggest how I should adjust today's shipment plan.”

The server attaches the structured analysis result data as context information. For example, the server formats a concise summary of the risk records, including risk type, predicted occurrence times, and recommended quantities, and sends this summary along with the compound prompt sentence to the generative AI model. The generative AI model processes both the prompt and the context to generate a detailed natural-language description or recommendation explaining why certain products are at risk, what the numerical predictions indicate, and what actions are recommended.

The server receives the generated natural-language text and performs post-processing. The server checks for undesired patterns, such as overly long sentences or missing references to key fields, and may truncate or lightly reformat the text. The server then encapsulates both the structured analysis result data and the generated text in response data destined for the terminal.

The terminal operates as an information display device. The terminal comprises a display unit, a network interface, and a processor executing a client application. The terminal receives the response data from the server and parses the structured analysis result data and natural-language content. The terminal generates graphical user interface elements such as tables, charts, and textual panels. The terminal displays current inventory quantities, predicted trajectories, and risk indicators, for example by drawing time-series graphs and highlighting predicted threshold crossings. The terminal simultaneously displays the natural-language explanation generated by the generative AI model so that the user can understand the computational results without reading raw numeric tables.

The user views the display and can choose to refine the request. The user can input additional constraints, such as a maximum budget or a specific time window, via the terminal's user interface. The terminal sends these additional parameters as part of a new request to the server. The server then adjusts the instruction sentence and potentially filters the structured analysis result data before calling the generative AI model again. This loop allows the system to deliver tailored recommendations while repeatedly leveraging the same trained prediction model and structured analysis data.

The server improves computer technology in several ways. The server reduces redundant transformations by enforcing a standardized internal format for inventory time-series records and for structured analysis result data. The server stores and retrieves data in a manner optimized for contiguous time-series access, which improves caching behavior and reduces memory copies. The server integrates the prediction model and the generative AI model through a defined context schema, which enables the server to reuse the same data structures for both numerical forecasting and natural-language generation, thereby reducing serialization overhead and network payload size when interfacing with the generative AI model.

The server also improves prediction accuracy and stability through the specific training procedure. By training a sequence model such as an LSTM on normalized and resampled time-series data with carefully selected features, the server captures temporal dependencies and periodic patterns more effectively than a simple rule-based or linear model. The choice of loss function, the use of early stopping, and the maintenance of a model registry contribute to producing models with lower prediction error and predictable behavior across different product categories.

The server further improves overall system performance by separating the computation of derived risk indicators from the generative AI model. The generative AI model operates on already computed structured analysis result data rather than re-deriving numerical risk information from unstructured text descriptions. This reduces the amount of numerical reasoning required inside the generative AI model and allows the server to constrain the model to primarily linguistic transformation and explanation tasks, which shortens inference time and lowers computational cost.

The described architecture goes beyond mere automation of human tasks. A human operator cannot feasibly perform high-frequency, per-product time-series normalization, model-based forecasting, threshold comparison, and structured context construction for input to a language model at the scale and speed achieved by the server. The server uses non-conventional, computer-specific data flows that exploit vectorized operations in numerical libraries, batched inference on neural network hardware, and structured context injection into a generative AI model. These operations produce lower latency, higher throughput, and more consistent explanations than conventional systems in which a human or a script manually inspects predictions and writes ad hoc notes.

The system can be implemented in various alternative embodiments. In one alternative, the server uses a different neural network architecture such as a temporal convolutional network or a transformer-based time-series model instead of an LSTM. In another alternative, the server uses a gradient boosting model with lagged features as the prediction model, while still generating structured analysis result data and feeding it to a generative AI model. In yet another variation, the server hosts the generative AI model locally on specialized hardware, using a model execution framework to reduce network latency, while retaining the same compound prompt and context schema.

The server can also incorporate additional features such as anomaly scores computed by an autoencoder trained on normal inventory patterns, and include these anomaly scores in the structured analysis result data. The generative AI model can then explain not only shortages and excesses but also unusual fluctuations detected by the autoencoder. This extension still follows the same architectural pattern of computing structured analysis results using specialized models and then using a generative AI model to transform those results into human-readable explanations.

By implementing these modules and data flows, the server, the terminal, and the user collectively realize the claimed system. The server performs specific, technically structured processing of time-series inventory data, the terminal provides a concrete machine interface that renders and interacts with this data, and the user issues prompt sentences and receives improved, technically generated explanations that are derived from integrated numerical and linguistic computations.

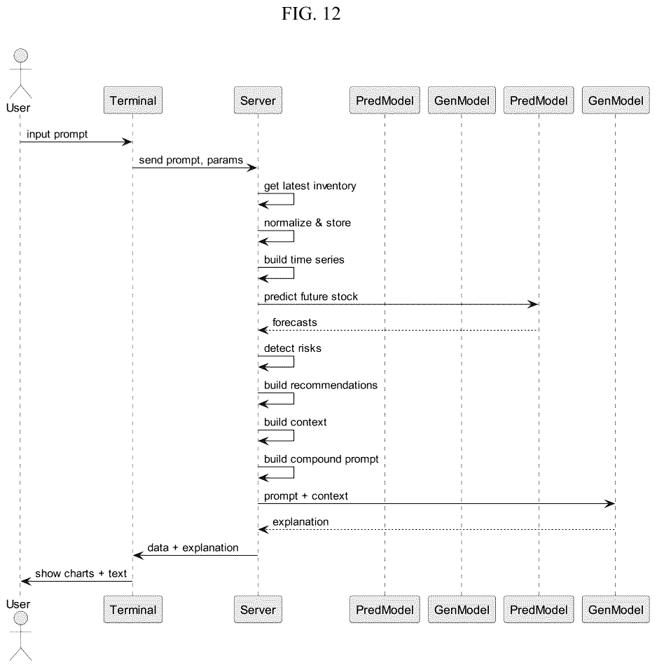

The following describes the processing flow using FIG. 12.

### Step 1

Server receives raw inventory data from multiple information sources as input. Server accepts messages from sensors, warehouse control systems, and business applications via a network interface, typically in formats such as JSON or CSV. Server parses each message to extract fields such as product identifier, location identifier, timestamp, and quantity value. Based on this input, server converts string-encoded values into internal numeric or symbolic representations, validates that mandatory fields are present, and discards or logs malformed records. Server outputs a set of validated, normalized records in an internal data structure such as an in-memory table.

### Step 2

Server converts the validated records into a standardized internal format and stores them. Server receives, as input, the in-memory records from Step 1. Server maps external product and location identifiers to internal keys using lookup tables stored in a database, converts all quantity units to a base unit (for example, pieces), and converts timestamps to a standard time zone. Server then writes the normalized records as rows into a time-series table in a storage device, indexing by product key and timestamp. The output of this step is a persistent, queryable time-series dataset for each product and location.

### Step 3

Server constructs time-series sequences for model input. Server reads, as input, normalized time-series records from the storage device. Server groups records by product key and resamples the data at fixed intervals (for example, every 30 minutes or every hour), filling missing intervals by interpolation or forward fill. Server creates sequences of fixed length (for example, the last 48 time steps) representing recent inventory history, and associates each sequence with future target values (for example, inventory quantities in the next 12 time steps). Server outputs training examples consisting of input sequences and corresponding target sequences.

### Step 4

Server preprocesses features for the prediction model. Server takes, as input, the training examples from Step 3. Server calculates additional features such as differences between consecutive inventory quantities, moving averages, and categorical indicators for day-of-week or holiday. Server scales numerical features using a normalization method (for example, min-max scaling) and encodes categorical features into numerical vectors. Based on this input, server packs the features and targets into tensors suitable for a neural network framework. Server outputs a set of training tensors split into training, validation, and test subsets.

### Step 5

Server trains the regression-type prediction model. Server receives, as input, the preprocessed training and validation tensors from Step 4. Server defines a neural network architecture (for example, an input layer, one or more recurrent layers such as LSTM layers, and a dense output layer), and initializes weights. Server repeatedly feeds input tensors through the network, computes predicted inventory quantities, and evaluates a loss function such as mean squared error against target quantities. Server performs backpropagation to compute gradients and updates weights using an optimization algorithm such as Adam. The output of this step is a trained prediction model with optimized parameters stored in a model file.

### Step 6

Server evaluates and selects the prediction model. Server takes, as input, the trained model and the validation and test tensors. Server runs inference on validation and test sets, calculates error metrics such as mean absolute error and root mean squared error, and compares these metrics with previously stored model versions. Based on this input, server determines whether the new model improves performance. Server outputs a selected model version identifier and stores the corresponding model parameters and metrics in a model registry.

### Step 7

Server prepares real-time input data for prediction. Server accepts, as input, the latest normalized inventory records stored in the time-series table. Server retrieves, for each product, the most recent sequence of time steps required by the prediction model (for example, the last 48 time points). Server applies the same feature engineering and scaling procedures used during training to ensure consistency. Based on this input, server constructs inference tensors representing current inventory history. Server outputs a batch of inference tensors ready for prediction.

### Step 8

Server runs the prediction model to compute future inventory transitions. Server takes, as input, the selected model and the inference tensors from Step 7. Server executes the model's forward pass to produce predicted inventory quantities over the predetermined future horizon (for example, the next 24 hours). The server does not update model weights in this step; it only performs numerical inference. Server collects predicted sequences per product and associates them with corresponding future timestamps. The output is a prediction dataset containing, for each product, a list of future time points and predicted inventory quantities.

### Step 9

Server derives risk indicators from prediction outputs. Server receives, as input, the prediction dataset from Step 8 and configuration data such as safety inventory levels and storage capacity levels for each product. Server scans each prediction sequence to identify the minimum and maximum predicted inventory quantities and their corresponding timestamps. Server compares these values against the configured thresholds. When a predicted quantity first drops below the safety level, server marks an inventory shortage risk and records the predicted occurrence time; when a predicted quantity first exceeds the capacity level, server marks an inventory excess risk. Server outputs a set of risk records containing product key, risk type, predicted occurrence time, predicted minimum or maximum quantity, and threshold values.

### Step 10

Server computes recommended replenishment or reduction quantities. Server accepts, as input, the risk records from Step 9 and target inventory levels defined in configuration data. For each shortage risk, server calculates a recommended replenishment quantity as the difference between a target inventory level and the predicted minimum quantity, optionally adjusted by safety margins. For each excess risk, server calculates a recommended reduction quantity as the difference between the predicted maximum quantity and an upper target level. Based on these computations, server updates each risk record to include a recommended quantity. Server outputs structured analysis result data that aggregates the enriched risk records.

### Step 11

Server constructs structured context for the generative AI model. Server takes, as input, the structured analysis result data from Step 10 and relevant metadata such as product names and categories. Server selects a subset of fields for each product, including risk type, predicted occurrence time, predicted minimum or maximum quantity, and recommended quantity, and arranges them in a consistent, compact representation. Server may filter to top-risk items based on severity or urgency. The output of this step is a structured context object that captures essential analytical information for use by the generative AI model.

### Step 12

Server receives a prompt sentence from the user. User operates the terminal and inputs a text query or instruction, such as:
“Based on the current inventory forecasts, explain which products are at highest risk of shortage in the next 24 hours and how I should prioritize replenishment.”

Terminal sends this prompt sentence to the server via a network request. Server accepts, as input, the raw prompt sentence and any additional parameters (for example, a time horizon or product filters). Server stores the prompt sentence and parameters in memory as part of a request context. Server outputs an internal representation of the user prompt for subsequent processing.

### Step 13

Server generates a system instruction sentence and combines it with the user prompt. Server receives, as input, the internal representation of the user prompt from Step 12 and the structured context object from Step 11. Server generates a system instruction sentence, for example:
“Summarize the inventory shortage and excess risks for the listed products, refer explicitly to predicted times and quantities, and propose concise operational actions.”

Server concatenates the user prompt sentence and the system instruction sentence into a compound prompt sentence, optionally separated by delimiters or markers. The output of this step is a finalized prompt sentence that encodes both user intent and machine instructions.

### Step 14

Server calls the generative AI model with the compound prompt sentence and structured context. Server takes, as input, the compound prompt sentence from Step 13 and the structured context object from Step 11. Server formats the context as supplementary text or structured fields appended to the prompt in accordance with the generative AI model's interface specification. Server sends the compound prompt sentence and formatted context to the generative AI model via an application programming interface or a local model invocation. The model processes the input and returns a natural-language output. Server receives, as output, generated text that explains the risks and recommended actions.

### Step 15

Server post-processes the generated natural-language explanation. Server accepts, as input, the text output from the generative AI model in Step 14. Server may parse the text to ensure that required information such as product names and risk types are present, and may truncate the text if it exceeds a predetermined length. Server may also insert section headers or bullet markers to improve readability. The output of this step is a cleaned and formatted natural-language explanation that is aligned with the structured analysis result data.

### Step 16

Server constructs response data for the terminal. Server takes, as input, the structured analysis result data from Step 10 and the formatted natural-language explanation from Step 15. Server packages these elements into a response object that includes fields for numerical predictions, risk indicators, recommended quantities, and textual explanations. Server encodes the response object into a transferable format and sends it to the terminal via a communication interface. The output of this step is a transmitted response carrying both structured data and natural-language content.

### Step 17

Terminal receives and parses the response data. Terminal accepts, as input, the response object sent by the server in Step 16. Terminal decodes the response, separates structured fields (such as predicted quantities, thresholds, and recommended quantities) from the textual explanation, and loads them into internal view models. The output is a set of UI-ready data structures that the terminal can render on the display.

### Step 18

Terminal renders inventory information and explanations on the display. Terminal takes, as input, the UI-ready data structures from Step 17. Terminal draws charts to show historical and predicted inventory trajectories, highlights predicted threshold crossings with visual markers, and displays tabular lists of risk items with predicted times and recommended quantities. Terminal presents the natural-language explanation generated by the generative AI model in a text panel, aligned with the visual charts. The output of this step is a graphical user interface that simultaneously shows numerical data and narrative guidance to the user.

### Step 19

User reviews the displayed information and optionally refines the query. User observes the charts, tables, and explanations rendered by the terminal in Step 18. Based on this output, user may identify products of interest and decide to ask follow-up questions. User inputs a refined prompt sentence, for example:
“Explain in simple terms why Product B and Product C are predicted to run out of stock tomorrow, and suggest how I should adjust today's shipment plan.”

Terminal sends this new prompt sentence and any selected product identifiers as input to the server, triggering another cycle of Steps 12 through 18 with updated parameters.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

In many application domains such as finance and insurance, computer systems are required to build and operate predictive models over large-scale historical data. Conventional systems typically hard-code data preprocessing logic, feature engineering procedures, model architectures, and evaluation workflows. As a result, any change in data characteristics, business requirements, or target metrics often forces human experts to manually redesign scripts, re-implement pipelines, and redeploy models. This causes significant latency, operational overhead, and inconsistency in model quality.

In existing architectures, the processor generally executes a fixed sequence of data cleaning and feature transformation steps that are decoupled from model evaluation results. When model performance degrades due to data drift, feature redundancy, or unsuitable hyperparameters, the system cannot automatically adapt its preprocessing and training strategy. Instead, engineers must manually inspect logs, tune hyperparameters, and adjust code, which leads to inefficient utilization of computational resources and suboptimal use of historical information.

Moreover, while generative AI models are capable of synthesizing program code from natural language specifications, conventional systems use such models only as auxiliary tools operated outside the main training and deployment loop. The output of the generative AI model is not tightly integrated with the runtime environment and is not automatically validated or orchestrated together with existing pipelines. This limits the ability of the system to self-configure or self-optimize based on explicit prompts and observed performance indicators.

From the perspective of computer technology, there is a need for a system architecture in which the processor can (i) systematically manage heterogeneous historical data sets per application domain, (ii) automatically perform data preprocessing, feature extraction, model training, and evaluation in a feedback loop, and (iii) leverage a generative AI model through prompt sentences to dynamically generate or modify executable program code and configuration information. Such an architecture should improve the efficiency and adaptability of the underlying computation, reduce manual engineering intervention, and enable the processor to more effectively exploit hardware and software resources for model lifecycle management. The technical problem to be solved is therefore to improve the functioning of a computer system that builds and operates prediction models, by enabling automatic, prompt-driven synthesis and execution of data processing and machine learning workflows that are iteratively refined based on performance evaluations.

The specific processing by the specific processing unit 290 of the data processing device 12 in Example 2 is realized by the following means.

The present invention provides a server comprising a processor and a storage device, the processor being configured to acquire, from a user terminal, a data set including a plurality of types of historical information related to an application domain, to store the data set in the storage device, to perform preprocessing on the data set by executing a data processing program to generate preprocessed data including completion of missing information, removal of anomalous information, and unification of information formats, to perform feature extraction processing and standardization processing on the preprocessed data by executing a feature transformation program so as to generate feature data suitable for machine learning processing including encoding of classification information and normalization of numerical information, to train a prediction model based on the feature data and teacher information included in the data set by executing a machine learning program and to generate an application-domain-specific prediction model by changing configuration elements and learning conditions of the prediction model in a plurality of patterns and selecting the prediction model based on performance indicators, to perform performance evaluation of the prediction model by inputting evaluation data to the prediction model, calculating accuracy, recall, and index values, and, based on the performance evaluation, resetting at least a part of the preprocessing, the feature extraction processing, or the learning conditions and retraining the prediction model, to generate a prompt sentence regarding specifications and processing procedures of the prediction model according to a usage purpose in the application domain, to input the prompt sentence to a generative information processing model, to cause the generative information processing model to generate program code or configuration information for automatically executing the preprocessing, the feature extraction processing, learning processing of the prediction model, and the performance evaluation processing, to execute or apply the generated program code or configuration information on the server, and to provide the generated prediction model or an analysis result obtained by using the prediction model in response to a request from an external device. This enables the computer system to automatically construct, adapt, and optimize end-to-end data processing and machine learning pipelines in response to domain-specific requirements and observed performance metrics, thereby improving computational efficiency, reducing manual intervention, and enhancing the technical functioning of the server in managing and executing predictive modeling workflows.

The term “system” refers to an information processing arrangement including at least one processor and at least one storage device configured to execute the functions described in the claims.

The term “processor” refers to one or more hardware processing units, such as a central processing unit or an accelerator, configured to execute instructions of one or more programs.

The term “storage device” refers to one or more non-transitory computer-readable media, such as a semiconductor memory device, a magnetic storage device, or an optical storage device, configured to store data and programs.

The term “user terminal” refers to an information processing apparatus operated by a user, such as a personal computer, a portable terminal, or a communication device, capable of transmitting data and instructions to the system.

The term “application domain” refers to a business or technical field, such as a claim field, a financial field, or an insurance field, for which prediction models and data analysis are performed.

The term “data set” refers to a collection of digital records including a plurality of types of historical information related to an application domain, such as attribute information, transaction information, or event information.

The term “historical information” refers to data representing past states, events, or transactions in an application domain, including, for example, past contracts, past claims, or past financial activities.

The term “preprocessing” refers to processing performed on a data set before feature extraction and model training, including, for example, completion of missing information, removal of anomalous information, and unification of information formats.

The term “completion of missing information” refers to a process of supplementing absent values in a data set by using predetermined rules, statistical values, or imputed estimates.

The term “removal of anomalous information” refers to a process of detecting and excluding or correcting data items whose values deviate from a predetermined normal range or pattern.

The term “unification of information formats” refers to a process of converting heterogeneous data types, representations, or encodings into a consistent format suitable for subsequent processing.

The term “data processing program” refers to a software component including instructions which, when executed by the processor, cause the processor to perform preprocessing on a data set.

The term “preprocessed data” refers to data generated by applying preprocessing to an original data set, having missing information completed, anomalous information removed, and information formats unified.

The term “feature extraction processing” refers to a process of deriving, selecting, or transforming input variables from preprocessed data into representations suitable as explanatory variables for a machine learning model.

The term “standardization processing” refers to a process of scaling or transforming numerical or categorical values of features into normalized representations, including, for example, normalization of numerical information and encoding of classification information.

The term “feature transformation program” refers to a software component including instructions which, when executed by the processor, cause the processor to perform feature extraction processing and standardization processing.

The term “feature data” refers to a set of transformed variables generated from preprocessed data by feature extraction processing and standardization processing, and usable as input to a machine learning model.

The term “classification information” refers to data representing a discrete category, label, or class of an entity, such as a type, a group, or a status.

The term “encoding of classification information” refers to a process of transforming classification information into a numerical or structured representation suitable for machine learning, such as binary encoding or index encoding.

The term “numerical information” refers to data expressed as numbers, such as counts, amounts, or continuous values.

The term “normalization of numerical information” refers to a process of transforming numerical information to a scaled range or distribution, such as zero-mean and unit-variance, for use in machine learning.

The term “machine learning program” refers to a software component including instructions which, when executed by the processor, cause the processor to perform training, updating, or inference of a prediction model based on feature data and teacher information.

The term “prediction model” refers to a parameterized computation structure, such as a statistical model or a neural network model, which outputs a prediction result based on input feature data.

The term “application-domain-specific prediction model” refers to a prediction model whose structure, parameters, or configuration are adapted to characteristics of a particular application domain.

The term “teacher information” refers to supervisory data, such as labels or target values, associated with records in a data set, used for training a prediction model.

The term “configuration elements of the prediction model” refers to structural components or settings of a prediction model, including, for example, the number of layers, the number of units, activation functions, or regularization parameters.

The term “learning conditions” refers to parameters and procedures controlling training of a prediction model, such as a learning rate, a batch size, a number of epochs, or optimization algorithms.

The term “performance indicators” refers to quantitative evaluation values, such as accuracy, recall, precision, F1-score, or other metrics, used to assess performance of a prediction model.

The term “evaluation data” refers to data, separate from training data, used to evaluate performance of a prediction model.

The term “performance evaluation” refers to a process of calculating one or more performance indicators based on outputs of a prediction model for evaluation data and corresponding teacher information.

The term “prompt sentence” refers to a natural language expression specifying requirements, specifications, or processing procedures of a prediction model, used as input to a generative information processing model.

The term “generative information processing model” refers to a generative AI model, such as a large language model, configured to generate text, program code, or configuration information based on a prompt sentence.

The term “program code” refers to machine-readable instructions, such as source code or executable code, which, when executed by the processor, cause the processor to perform specific processing.

The term “configuration information” refers to structured parameters, settings, or definitions, such as pipeline configurations or model hyperparameters, used to control execution of preprocessing, feature extraction, model training, or evaluation.

The term “learning processing of the prediction model” refers to a sequence of operations including training, updating, or fine-tuning parameters of a prediction model based on feature data and teacher information.

The term “performance evaluation processing” refers to a sequence of operations by which performance indicators of a prediction model are computed and recorded.

The term “external device” refers to any information processing apparatus distinct from the system, such as a client terminal, another server, or an external service, capable of transmitting a request to and receiving a response from the system.

The term “analysis result” refers to information derived from applying a prediction model to input data, including predicted values, scores, probabilities, or derived indicators.

The term “information providing interface” refers to a software-defined interface, such as an application programming interface, through which an external device can transmit a request to invoke a prediction model and receive a response containing a prediction result.

In an embodiment, a server includes a processor, a main memory, a persistent storage device such as a solid-state drive, and a communication interface connected to a network. The server executes an operating system and a plurality of software components, including a data processing program, a feature transformation program, a machine learning program, a generative AI model client program, and an application programming interface (API) program. A terminal operated by a user includes a processor, a memory, a display, an input device, and a communication interface. The terminal executes a browser or a dedicated client application to communicate with the server. The user operates the terminal to supply data and instructions to the server and to receive prediction results.

The server uses the data processing program, which is implemented in a programming language such as a scripting language and includes calls to a data analysis library such as a tabular data manipulation library, to load and preprocess data sets. The data sets include multiple tables or files containing historical information related to an application domain, such as records of entities, records of contracts, and records of events. Each record includes a set of fields representing attributes such as numerical values, categorical values, and time stamps. The server stores the raw data sets in the persistent storage device in a structured format, such as relational tables or columnar files.

The server uses the data processing program to perform completion of missing information by computing statistical values (for example, means, medians, or modes) over observed values and inserting those values into missing entries. For categorical attributes, the server replaces missing entries with a special category value. The server detects anomalous information by computing distribution statistics such as standard deviation and percentile ranges and by flagging values that exceed configurable thresholds. The server removes or corrects such flagged entries to generate preprocessed data. The server converts textual date representations into an internal time representation and normalizes different encodings (for example, different country codes) into a single canonical code set. As a result, the server generates a consistent internal data structure, such as a two-dimensional array or a matrix representation, that can be efficiently processed by subsequent modules.

The server uses the feature transformation program, which invokes a machine learning library such as a general-purpose learning toolkit, to perform feature extraction and standardization. The server defines a mapping between original data fields and feature vectors, separating categorical fields and numerical fields. The server applies encoding of classification information, such as one-hot encoding or ordinal encoding, to categorical fields to generate sparse or dense numerical vectors. The server applies normalization of numerical information, such as z-score scaling or min-max scaling, to numerical fields to ensure that features are on comparable scales. The server optionally generates derived features, such as counts, ratios, interaction terms, and time-window aggregations, customized for each application domain. The resulting feature data is stored as numerical arrays in main memory and optionally written to intermediate storage in binary format for reuse.

The server uses the machine learning program to train a prediction model. In one embodiment, the server constructs a neural network model implemented with a neural network toolkit such as a tensor-based computation framework. The prediction model includes an input layer whose dimensionality equals the length of the feature vectors, one or more hidden layers with fully connected units and nonlinear activation functions such as rectified linear units, and an output layer whose size corresponds to the prediction task, such as a single unit with a sigmoid function for binary classification. The server defines a loss function, for example a binary cross-entropy function, that measures the discrepancy between predicted outputs and teacher information representing true labels. The server initializes model weights according to a known initialization scheme and uses an optimization algorithm such as a stochastic gradient descent method with adaptive learning rates.

The server trains the prediction model by iteratively supplying mini-batches of feature data and teacher information to the neural network. For each mini-batch, the server performs a forward propagation computation to obtain predicted outputs, computes the loss using the loss function, backpropagates gradients through the network to compute partial derivatives with respect to each weight, and updates the weights according to the optimization algorithm. The server repeats this process for multiple epochs. The server adjusts learning conditions such as learning rate, batch size, number of epochs, and regularization parameters (for example, dropout probability or L2 penalty coefficients) to improve convergence properties and generalization performance.

The server evaluates the prediction model by computing performance indicators including accuracy, recall, precision, F1-score, and optionally area under a receiver operating characteristic curve. The server uses evaluation data that is separated from the training data. The server compares the predicted labels with the teacher information in the evaluation data and calculates the performance indicators. The server records the indicators in a log structure and may store them in a performance history table in the persistent storage device. If the performance indicators do not meet predefined thresholds, the server resets at least part of the preprocessing configuration, the feature extraction configuration, or the learning conditions, and retrains the prediction model. In this feedback loop, the server can, for example, change the set of selected features, alter normalization strategies, modify the number of hidden layers, or adjust learning rates. This iterative adaptation directly changes the computational pattern and memory access pattern in the processor, thereby reducing unnecessary calculations and improving overall training efficiency.

The server manages data sets separately for each application domain. The server associates each record with a domain identifier and stores domain-specific schemas and preprocessing configurations. For example, in a claim-related domain, the server uses features such as number of past claims and total claim amount; in a financial domain, the server uses features such as transaction frequency and account balance volatility; in an insurance domain, the server uses features such as policy duration and coverage amount. The server maintains a mapping between domain identifiers and feature extraction pipelines and uses this mapping to automatically select appropriate pipelines at runtime. This domain-based management allows the server to reuse models and processing pipelines efficiently, reducing redundancy and storage overhead.

The server integrates a generative AI model client program to interact with a generative AI model, such as a large language model deployed on a remote computation platform or on specialized accelerator hardware connected to the server. The server represents a prompt sentence as a text string in a structured template. The server constructs prompt sentences that describe specifications and processing procedures of prediction models, including desired input fields, preprocessing methods, feature engineering strategies, model architectures, optimization algorithms, and evaluation metrics.

The server generates a prompt sentence, for example:
“Using the last 5 years of health insurance policyholder data, generate Python-like code that: 1) loads CSV files with customer demographics and claim histories, 2) cleans missing values and removes outliers using tabular data manipulation operations, 3) creates features such as total past claims and average annual premium using a general-purpose machine learning toolkit, 4) trains a binary classification neural network model with a tensor-based computation framework to predict whether a policyholder will file a claim next year, 5) evaluates the model using accuracy, recall, and F1-score, and 6) defines an API endpoint ‘/predict’ that returns claim risk probabilities.”
In another example, the server generates a prompt sentence:
“Design a feature engineering pipeline for life insurance data, including age, income, policy duration, coverage amount, and claim history. Provide operations that apply column-wise transformations, encode categorical variables, and standardize numerical variables, and explain how each transformation affects model performance.”

The server transmits the prompt sentence to the generative AI model through the generative AI model client program using a network protocol. The generative AI model returns text that includes program code descriptions or configuration descriptions corresponding to preprocessing, feature extraction, training, evaluation, and deployment. The server parses the returned text and converts it into structured configuration information, such as lists of preprocessing operations, neural network layer definitions, optimizer choices, and evaluation settings. The server may store these configurations in a configuration repository and may validate them by performing small-scale test runs on sample data.

The server applies the generated configuration information to update its internal data processing program, feature transformation program, and machine learning program without manual coding by the user. For example, when the generative AI model suggests adding an additional hidden layer or changing the activation function from a rectified linear unit to an exponential linear unit, the server updates the corresponding neural network definition. When the generative AI model suggests using a different normalization method or adding new derived features, the server updates the feature transformation pipeline. This mechanism allows the system to alter internal computation graphs and data flows at runtime in a way that is driven by high-level natural language specifications yet results in precise algorithmic changes.

The server executes the modified pipelines and models, evaluates their performance, and can use updated performance indicators to generate further prompt sentences to refine the configuration. As a result, the server realizes an iterative loop in which the processor not only executes static code but also orchestrates dynamic reconfiguration of its own software pipeline guided by generative outputs and measurable performance. This structure goes beyond mere automation of human scripting work. The server is able to systematically explore combinations of preprocessing steps, feature sets, and learning conditions that would be impractical to fully enumerate manually and to converge on efficient configurations that reduce processing time, memory consumption, and communication overhead while improving predictive accuracy.

The terminal provides a user interface that allows the user to select application domains, upload data, configure target variables, and visualize model performance. The terminal renders evaluation results such as confusion matrices, receiver operating characteristic curves, and precision-recall curves that are generated by the server. The user may adjust high-level preferences, such as prioritizing recall over precision, which the server incorporates into its prompt sentences and evaluation criteria. In this way, the user influences model behavior at a policy level, while the technical details of preprocessing pipelines, feature transformations, and neural network architectures are determined and executed by the server.

The server can, in some embodiments, control additional computing resources such as hardware accelerators or distributed processing nodes. For example, the server may allocate training jobs to different graphics processing units depending on model size and data volume. The server may adjust batch sizes such that the utilization of accelerator memory is maximized without causing overflow. The dynamic configuration generated through the generative AI model can specify different training schedules, distribution strategies, or parallelization schemes, which the server uses to orchestrate computation across nodes. This control leads to technical benefits including reduced training time and balanced resource usage.

The described architecture improves computer technology in several ways. First, by separating domain-specific configuration from the core execution engine and by automatically generating and updating configurations via the generative AI model, the server reduces the need for frequent redeployment of monolithic programs and enables finer-grained adaptation at runtime. This results in reduced downtime and lower risk of configuration errors. Second, by directly tying preprocessing and feature transformation configuration to measured performance indicators and by using those indicators to drive reconfiguration, the server creates a feedback-controlled computation process that adapts to data drift and changing distributions, improving predictive accuracy and robustness over time. Third, by representing data pipelines and model architectures as structured configurations rather than hard-coded sequences, the server can efficiently cache intermediate results, share common transformations across multiple models, and avoid redundant computations, thereby improving computational efficiency and reducing storage and communication loads.

The server applies rule sets and non-conventional procedures during automatic configuration, which differ from typical human-developed static pipelines. For instance, the server may use a rule that increases model capacity only when validation accuracy increases over a certain threshold while controlling for overfitting by monitoring changes in loss on a separate hold-out set. The server may apply a heuristic that prefers transformations reducing feature sparsity to improve cache locality and accelerate matrix operations on the hardware. These rules are encoded as explicit criteria inside the configuration interpreter and are applied systematically, enabling the server to optimize its operations according to objective performance and resource metrics rather than subjective human judgments.

In alternative embodiments, the server may employ different types of machine learning models, such as gradient boosting machines, probabilistic graphical models, or recurrent neural networks, while preserving the same architecture of generative configuration and feedback-driven adaptation. The generative AI model can generate configuration information that selects among these model types or combines them in ensemble structures. The server can then instantiate and train the selected models using corresponding libraries. In each case, the key technical aspect is that the processor is configured to treat model designs, learning parameters, and data transformations as mutable objects that are systematically generated, applied, evaluated, and iteratively refined, rather than as static artifacts manually coded once and rarely updated.

In this manner, the server, the terminal, and the user cooperate to implement the claimed system. The server performs concrete data transformations and numeric computations on specific data structures using defined algorithms and model architectures; the terminal provides interaction and visualization; and the user supplies domain context and high-level objectives through prompt sentences and configuration choices. The combination of automated generative configuration, structured feedback based on quantitative performance indicators, and domain-specific data management yields technical effects including improved processing speed, enhanced prediction accuracy, reduced error rates, and more efficient utilization of computing and communication resources compared with conventional static pipeline systems.

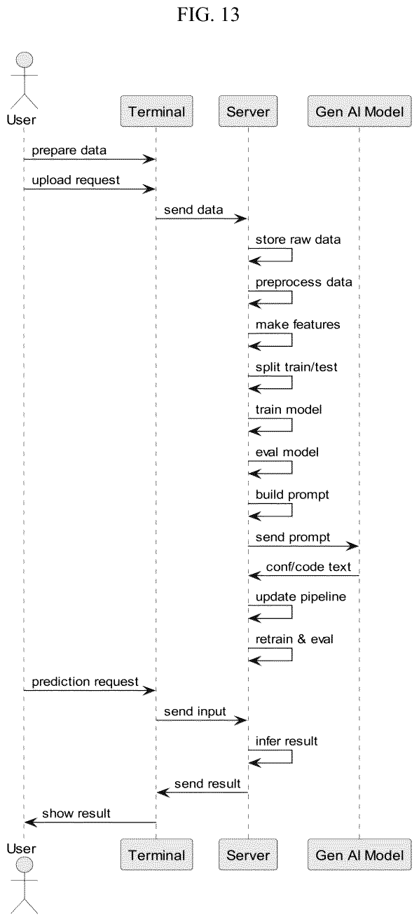

The following describes the processing flow using FIG. 13.

### Step 1

The user prepares domain-specific historical data on the terminal.

The user collects records such as entity attributes, contract information, and event histories and stores them in files (for example, comma-separated text files or spreadsheet files) on the terminal.

Input: raw domain data available on the terminal in local files.

Output: a set of local data files ready for upload from the terminal.

### Step 2

The terminal transmits the data set and metadata to the server.

The terminal executes a browser or client application, opens an upload interface provided by the server, and attaches one or more local files together with metadata such as application domain identifier, target variable name, and file format description. The terminal sends these as a network request to the server over a secure communication protocol.

Input: local data files and metadata specified by the user.

Output: a network request containing the raw data set and metadata delivered to the server.

### Step 3

The server receives and stores the raw data set.

The server parses the network request, validates file formats and schema (for example, checks for required columns and type consistency), and writes the raw data set into a storage device as structured tables or files. The server also records metadata such as upload time, field names, and domain identifiers in a management table.

Input: network request containing raw data and metadata.

Output: stored raw data in persistent storage and registered metadata in a management structure.

### Step 4

The server performs basic preprocessing to generate preprocessed data.

The server loads the raw data from the storage device into main memory using a data processing program. The server scans each column to detect missing entries and replaces them with computed values such as mean, median, or mode, or with a special placeholder category. The server calculates statistical ranges for numerical columns, identifies outliers beyond configured thresholds, and removes or caps such values. The server converts textual date strings and categorical codes into canonical internal representations.

Input: raw data retrieved from persistent storage and schema information.

Output: preprocessed data with completed missing values, reduced outliers, and unified formats, stored in memory and optionally persisted as a cleaned table.

### Step 5

The server generates feature data through feature extraction and standardization.

The server divides the preprocessed data into feature columns and target columns according to metadata. The server applies encoding operations to categorical columns, such as one-hot encoding, to transform categories into numerical vectors. The server applies scaling operations such as z-score normalization or min-max scaling to numerical columns. The server may compute additional derived features such as aggregated counts, ratios, and time-window statistics.

Input: preprocessed data and configuration specifying feature and target columns.

Output: numerical feature arrays and target label arrays suitable for machine learning, stored in memory.

### Step 6

The server partitions the feature data into training data and evaluation data.

The server uses a data splitting procedure to randomly divide the feature arrays and target labels into a training subset and an evaluation subset according to a specified ratio. The server ensures reproducibility by fixing a random seed and may apply stratified sampling to preserve label distributions.

Input: complete feature arrays and target label arrays.

Output: training feature arrays and labels, and evaluation feature arrays and labels.

### Step 7

The server trains an initial prediction model.

The server initializes a machine learning model, for example a neural network with an input layer whose size matches the feature vector dimension, several hidden layers with non-linear activation functions, and an output layer suitable for the prediction task. The server selects a loss function such as cross-entropy and an optimizer such as an adaptive gradient method. The server iteratively processes mini-batches of training data, performs forward propagation to compute predictions, calculates loss, backpropagates gradients, and updates model parameters.

Input: training feature arrays and labels, together with model hyperparameters and initialization settings.

Output: a trained prediction model with learned parameters stored in memory and optionally persisted to storage.

### Step 8

The server evaluates the prediction model using evaluation data.

The server applies the same feature transformation to the evaluation data as used for the training data if necessary and feeds the evaluation feature arrays into the trained prediction model to obtain predicted outputs. The server compares predicted labels or probabilities with true labels to compute performance indicators such as accuracy, recall, precision, and F1-score. The server records these indicators and the corresponding configuration of preprocessing and model parameters.

Input: evaluation feature arrays, evaluation labels, and the trained prediction model.

Output: performance indicators and evaluation logs stored in a performance history structure.

### Step 9

The server determines whether to adjust preprocessing, feature extraction, or learning conditions.

The server checks the performance indicators against predefined thresholds or optimization criteria. If a metric such as F1-score or recall is below a required level, the server identifies potential adjustment strategies, such as changing the subset of features, altering normalization methods, modifying network depth or width, or tuning learning rates and batch sizes. The server updates a configuration object that defines these processing parameters.

Input: performance indicators and current configuration of preprocessing and model parameters.

Output: an updated configuration describing modified preprocessing rules, feature transformations, and learning conditions.

### Step 10

The server retrains the prediction model based on the updated configuration.

The server rebuilds or updates the feature transformation pipeline according to the new configuration and regenerates feature arrays if required. The server reconstructs the prediction model architecture or adjusts its hyperparameters. The server retrains the model using the training data, again performing iterative forward and backward computations and parameter updates. The server then re-evaluates the model using the evaluation data to produce new performance indicators.

Input: preprocessed data, updated configuration, and evaluation data.

Output: a refined prediction model and updated performance indicators.

### Step 11

The server generates a prompt sentence that describes desired specifications and processes.

The server constructs a textual prompt sentence based on the current domain, performance indicators, and configuration. The prompt sentence describes, in natural language, required data loading operations, preprocessing methods, feature engineering steps, model architecture details, optimization algorithms, and evaluation metrics, and may specify an interface specification for serving predictions.

Input: domain information, current performance results, and configuration details.

Output: a structured prompt sentence in text form suitable for submission to a generative AI model.

### Step 12

The server sends the prompt sentence to a generative AI model and receives generated configuration or code descriptions.

The server uses a generative AI model client program to transmit the prompt sentence to a generative AI model over a network. The generative AI model returns text that describes program structures, processing pipelines, or configuration settings corresponding to the prompt. The server parses this text, identifies specific instructions such as sequences of preprocessing operations, neural network layer definitions, and evaluation steps, and converts them into internal configuration structures.

Input: prompt sentence and connection parameters for the generative AI model.

Output: generated configuration descriptions or code-like specifications in a structured internal representation.

### Step 13

The server applies the generated configuration to update the processing pipeline.

The server merges or replaces existing configuration elements with those obtained from the generative AI model. The server updates the data processing program to use new preprocessing steps, modifies the feature transformation program to apply new feature encodings or derived features, and adjusts the machine learning program to construct and train models according to the generated architecture and hyperparameters.

Input: existing configuration and generated configuration descriptions.

Output: an updated end-to-end processing pipeline definition stored in configuration storage and activated for subsequent runs.

### Step 14

The server executes the updated pipeline and records improved operational characteristics.

The server reruns data loading, preprocessing, feature extraction, training, and evaluation according to the updated pipeline. The server measures not only prediction performance indicators but also computational metrics such as training time, memory usage, and inference latency. The server stores these metrics in association with the configuration version, enabling comparison between different pipeline variants.

Input: raw or preprocessed data sets and the updated pipeline definition.

Output: a newly trained prediction model, updated performance indicators, and system-level operational metrics.

### Step 15

The server provides the final prediction model and analysis results to the terminal.

The server exposes an interface through which the terminal can send new input records for prediction. The server receives such requests, applies the established preprocessing and feature transformation to the input data, executes the prediction model, and returns prediction outputs such as risk scores or probability values. The terminal displays these outputs to the user in a visualization or report format.

Input: new input data from the terminal and the deployed prediction model.

Output: prediction results transmitted to the terminal and displayed to the user.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional computer-implemented analytics systems are primarily designed as static data pipelines: data are preprocessed, a fixed predictive or anomaly-detection model is applied, and results are visualized or stored. Such systems exhibit several technical limitations. First, processing pipelines and security mechanisms are not dynamically optimized based on real-time user context, such as the user's emotional state, which results in inefficient utilization of computing resources and either over-provisioned or under-provisioned security and processing latency. Second, anomaly-detection and forecasting engines generally operate independently from explanation engines, so that the processor must run separate, uncoordinated components for prediction, visualization, and explanation. This fragmentation leads to redundant data transformations, increased memory consumption, and additional inter-process communication overhead, thereby degrading throughput and responsiveness. Third, existing systems do not provide an integrated mechanism by which a processor can automatically formulate prompt sentences and exploit a generative AI model to generate machine-interpretable configuration information and human-readable explanatory text, and then feed such information back into the live control loop of the data-processing system. As a result, explanation, configuration, and prediction remain loosely coupled, and must often be orchestrated manually or through ad hoc scripts.

Furthermore, traditional dashboards are rendered according to static templates that do not react to real-time emotion estimation, anomaly severity, or domain-specific policies. Consequently, the processor cannot automatically adjust data processing speed, analysis focus, visualization layout, and security level in a coordinated manner; instead, these parameters are typically fixed or changed only through manual configuration. This static behavior leads to suboptimal performance, for example by applying the same encryption and access-control overhead even when high responsiveness is temporarily more important, or by failing to increase verification and security when indicators suggest risk or user distress. There is therefore a need for a computer-implemented system in which a processor integrates (i) high-speed, parallel data processing, (ii) emotion-aware adjustment of processing and security parameters, and (iii) generative-AI-based explanation and configuration, in a unified architecture that reduces computational overhead, improves responsiveness, and provides technically improved control over data processing and visualization.

The specific processing by the specific processing unit 290 of the data processing device 12 in Application Example 2 is realized by the following means.

The present invention provides a server comprising a processor configured to perform parallel processing on data to execute high-speed processing; to train a machine learning model using past data sets to generate a prediction model or an anomaly detection model; to preprocess time-series data, transaction data, inventory data, or usage history data to generate feature data by performing at least missing-value completion, normalization, and encoding; to execute the prediction model or the anomaly detection model based on the feature data to calculate a prediction result or an anomaly index and to identify an anomalous event by comparing the prediction result or the anomaly index with a predetermined threshold; to execute an emotion estimation model to generate emotion state information by estimating a user's emotional state based on voice information or image information acquired from a user terminal; to dynamically adjust at least one of a data processing speed, a data analysis policy, an information visualization format, and an information security level based on the emotion state information and the prediction result or the anomaly index; to generate visualization information that is displayable as a real-time dashboard screen while protecting the data and the prediction result by encryption processing and access control processing; and to input a prompt sentence relating to at least one of the prediction result, the anomaly index, and the emotion state information to a generative AI model, obtain a response including at least one of an explanatory text, an analysis policy, and configuration information from the generative AI model, and reflect the response in an operation of the processor or in an operation of a user terminal. This enables the server to implement a technically improved, closed-loop data-processing architecture in which prediction, anomaly detection, emotion-aware control of processing and security parameters, real-time visualization, and generative-AI-driven explanation and configuration are integrated within a single processor-controlled pipeline, thereby reducing redundant computation and data movement, improving throughput and responsiveness, and providing adaptive control over how data are processed, protected, and presented.

The term “processor” refers to a hardware or virtual computation unit, such as a central processing unit, graphics processing unit, or cloud-based compute instance, that executes program instructions to perform data processing operations.

The term “parallel processing” refers to a mode of operation in which a processor executes multiple computational tasks or processes multiple data elements concurrently, using multiple cores, threads, or processing units to increase throughput and reduce latency.

The term “data set” refers to a collection of structured or unstructured data items, such as records, samples, or events, that are used as input for training, validating, or executing a computational model.

The term “machine learning model” refers to a computational model, such as a regression model, classification model, clustering model, neural network, or anomaly detection model, that has parameters adjusted based on training data to learn patterns or relationships.

The term “prediction model” refers to a type of machine learning model that outputs a forecast, estimate, or expected value for a future or unknown variable based on input feature data.

The term “anomaly detection model” refers to a type of machine learning model that computes an index or score indicating how much a given data point deviates from a learned normal pattern or distribution.

The term “time-series data” refers to data items that are associated with timestamps and ordered in time, such as sensor readings, transaction logs, or system metrics.

The term “transaction data” refers to records representing discrete operations, such as financial transactions, purchase events, or service requests, each including at least an identifier, a timestamp, and one or more attribute values.

The term “inventory data” refers to records representing quantities, locations, or movement histories of physical or virtual items managed within a storage or logistics environment.

The term “usage history data” refers to records indicating past behavior or interactions of a user, device, or system, such as access logs, operation logs, or application usage events.

The term “preprocess” refers to performing one or more transformation operations on raw data, such as cleaning, formatting, aggregation, or feature extraction, to obtain data suitable for input to a computational model.

The term “feature data” refers to numerical or categorical representations derived from raw data, including scaled, encoded, or otherwise transformed variables that are provided as input to a machine learning model.

The term “missing-value completion” refers to a processing operation that replaces absent or undefined data entries with substitute values, such as statistical aggregates or inferred values, to produce a complete data set.

The term “normalization” refers to a transformation of numerical data into a standardized scale, such as rescaling to a fixed range or transforming to have a specific mean and variance, to stabilize and improve model performance.

The term “encoding” refers to a transformation that converts non-numerical values, such as categorical labels, textual tokens, or identifiers, into numerical or structured representations suitable for computation.

The term “prediction result” refers to an output value or set of values produced by a prediction model, such as a predicted numeric value, a classification label, or a probability distribution.

The term “anomaly index” refers to a numerical score or indicator output by an anomaly detection model that quantifies a degree of deviation of an input data point from a learned normal pattern.

The term “threshold” refers to a predetermined value or range used to compare with an index, score, or metric, in order to classify an input as normal or abnormal, or to trigger a specific action.

The term “anomalous event” refers to a data point, transaction, or situation that is classified as abnormal or suspicious based on comparison of an anomaly index or prediction result with a threshold.

The term “emotion estimation model” refers to a computational model that receives sensor information, such as voice or image data, and outputs a label or score representing a user's emotional state.

The term “emotion state information” refers to data indicating an estimated emotional condition of a user, such as joy, anger, sadness, neutrality, or a similar emotional category, optionally including confidence scores.

The term “user terminal” refers to a user-operated device, such as a smartphone, tablet, wearable device, or computer, that communicates with the server to send or receive data, including voice or image information.

The term “data processing speed” refers to a rate or latency characteristic associated with processing data, including throughput, batch size, or response time, which may be adjusted by controlling resource allocation or scheduling.

The term “data analysis policy” refers to a set of rules or parameters that determine how data are analyzed, including which models are used, which features are emphasized, and which scenarios or outcomes are prioritized.

The term “information visualization format” refers to a set of layout, style, and rendering parameters used to present information on a display, such as chart types, color schemes, fonts, and arrangement of visual elements.

The term “information security level” refers to a degree or configuration of security controls applied to data, including encryption strength, access-control strictness, logging level, and authentication requirements.

The term “visualization information” refers to processed data and associated configuration parameters that define content, structure, and appearance of a graphical representation to be rendered on a display.

The term “real-time dashboard screen” refers to a graphical user interface that presents current or near-current information using visual elements such as charts, tables, and indicators, and automatically updates as new data are processed.

The term “encryption processing” refers to a computational operation that transforms plaintext data into ciphertext by using a cryptographic algorithm and key, in order to protect the confidentiality of the data.

The term “access control processing” refers to a set of operations that authenticate entities and authorize or deny access to data or functions based on credentials, roles, or policies.

The term “generative AI model” refers to an artificial intelligence model, such as a generative language model, that generates new data, including text or configuration content, in response to an input prompt.

The term “prompt sentence” refers to a natural-language or structured instruction string provided as input to a generative AI model to specify a task, context, or desired output characteristics.

The term “explanatory text” refers to human-readable text produced by a generative AI model or other component that describes reasons, factors, or context associated with a prediction result, anomaly index, or system behavior.

The term “configuration information” refers to data that define or modify operational parameters of a system, such as thresholds, model selection, visualization settings, and security policies, and that can be interpreted by the processor to change behavior.

In one embodiment, a server executes a program on a hardware platform that includes at least one central processing unit, optionally at least one graphics processing unit, a volatile memory device, a non-volatile storage device, and a network interface. The server runs a general-purpose operating system and an application stack that includes an application framework, a numerical computation library, and a machine learning framework. The server communicates, via the network interface, with multiple terminals operated by users. Each terminal includes at least one processor, a memory, a display device, one or more input devices, and one or more sensors such as a camera and a microphone.

The server stores, in the non-volatile storage device, program modules including a data ingestion module, a preprocessing module, a model training module, a model inference module, an emotion estimation module, a visualization control module, a security control module, and a generative-AI interaction module. The server further stores model parameter sets, configuration files, and log data. The server loads these modules and data into the memory and executes them on the processor.

The server generates the program for implementing the claimed system by defining, within the machine learning framework, at least one prediction model and at least one anomaly detection model. The server also defines, within the machine learning framework or an external emotion recognition service, an emotion estimation model. In addition, the server configures a generative AI model interface that accepts a prompt sentence and returns a textual response.

The server uses a numerical computation library to represent data in a structured form, for example as multi-dimensional arrays or labeled tables. The server represents time-series data, transaction data, inventory data, and usage history data as records each including at least a timestamp field, one or more numeric fields, and one or more categorical fields. The server stores such data in a data store organized by keys such as user identifiers, device identifiers, and domain identifiers (for example, financial, logistics, or retail).

The server employs the preprocessing module to perform data transformation operations. The server uses a data-frame library to read raw records and to compute missing-value completion values such as per-feature means or medians. The server replaces missing entries in numeric fields with these computed values. The server normalizes numeric fields by applying, for example, a z-score transformation that subtracts a per-feature mean and divides by a per-feature standard deviation. The server encodes categorical fields, such as location category or device type, either using one-hot vectors or using integer indices mapped to embedding vectors. As a result, the server generates feature data in a form suitable for efficient vectorized computation on the processor or graphics processing unit. This transformation reduces branching and irregular memory access, which in turn improves cache locality and execution throughput.

The server configures the prediction model as, for example, a feed-forward neural network with an input layer corresponding to the dimensionality of the feature data, one or more hidden layers, and an output layer that produces either a scalar regression value or a probability vector. The server may use rectified linear unit activation functions in the hidden layers and a linear or sigmoid activation function in the output layer. The server defines a loss function, such as mean squared error for regression or cross-entropy for classification, and uses an optimization algorithm, such as a gradient-based optimizer, to update weight parameters. The server trains this prediction model using past data sets stored in the data store. During training, the server retrieves batches of feature data and corresponding ground-truth labels, computes forward passes to obtain predictions, computes the loss, computes gradients via backpropagation, and updates the weights. The server repeats this process over multiple epochs and monitors validation metrics to prevent overfitting.

The server configures the anomaly detection model as, for example, an autoencoder or an isolation-based model. For an autoencoder, the server defines an encoder network that maps high-dimensional feature data into a lower-dimensional latent representation, and a decoder network that reconstructs the feature data from the latent representation. The server trains the autoencoder on historical data assumed to represent normal behavior by minimizing a reconstruction error metric such as mean squared error between inputs and outputs. After training, the server computes, for each new data point, a reconstruction error that serves as an anomaly index. The server compares this anomaly index with a threshold to determine whether the data point corresponds to an anomalous event. The server may determine the threshold dynamically, for example by selecting a percentile of reconstruction errors on validation data, which provides a statistically grounded cutoff and reduces false positives.

The server configures the emotion estimation model as a combination of acoustic and visual submodels. The server uses an audio feature extractor to compute, from voice signals captured by the microphone of a terminal, features such as pitch contour, energy contour, and spectral coefficients. The server then feeds these features into a neural network classifier that outputs an emotion label. The server also applies an image processing library to frames captured by a camera of the terminal to detect a face and to extract facial landmarks or encoded embeddings. The server feeds the extracted facial features into a neural network classifier trained to distinguish among emotion categories such as joy, anger, and neutral. The server fuses the outputs of the acoustic and visual submodels, for example by averaging probability distributions or by using a small fully connected fusion layer. The server therefore generates emotion state information including an emotion label and a confidence score. By explicitly defining these multi-modal feature extraction and fusion steps, the server performs emotion estimation in a structured, repeatable way that improves robustness compared to simple rule-based heuristics.

The terminal executes a client application that captures user inputs and sensor data. The terminal uses a camera interface to obtain periodic image frames of the user and a microphone interface to obtain audio frames. The terminal optionally compresses or downsamples these frames to reduce bandwidth and then transmits them to the server via a secure communication protocol. The terminal also obtains user interaction events, such as touches on UI elements, and transmits metadata describing the user's current context, for example “reviewing fraud alert” or “monitoring inventory dashboard.”

The server uses the security control module to protect data. The server applies encryption processing to sensitive data before writing them to storage or transmitting them to the terminals. The server manages cryptographic keys in a key store and performs encryption and decryption operations using a symmetric algorithm. The server applies a secure communication protocol to all communications with the terminals. The server also performs access control processing by verifying credentials and tokens presented by the terminals, checking associated roles and permissions, and allowing or denying access to resources accordingly. By integrating encryption and access control at the level of individual data flows, the server reduces the risk of unauthorized access without requiring separate security appliances.

The server uses the visualization control module to generate visualization information for real-time dashboards. The server defines visualization configurations including chart types, axes, color schemes, and layout templates. The server selects and aggregates data such as prediction results, anomaly indices, and emotion state distributions, transforms them into chart-ready structures, and combines them with visualization configurations. The server then sends these combined structures to the terminals. The terminals render the dashboards using graphical toolkits, applying the specified color schemes and layouts. Because the server provides pre-aggregated and pre-formatted visualization data, the terminals perform minimal computation, which reduces processing load and improves display latency.

The server dynamically adjusts processing parameters based on emotion state information and model outputs. For example, when the server determines that a user is likely in a joyful state and that anomaly indices are low, the server may increase batch sizes for processing and reduce redundant verification steps, which improves throughput. Conversely, when the server detects anger or high anomaly indices, the server may decrease batch sizes, enable additional validation checks, and enforce stricter access-control policies. These changes are implemented by modifying internal configuration values that control scheduler behavior, model invocation frequency, and security module settings. The server thereby alters the internal operation of the computer system in response to emotion and anomaly context, rather than merely altering displayed content. This leads to technical effects such as reduced average latency in low-risk contexts and improved detection of misuse or error in high-risk contexts.

The server interacts with a generative AI model through the generative-AI interaction module. The server constructs a prompt sentence that describes the current context, the data, and the desired output. For example, the server may generate the following prompt sentence:
“Explain why this transaction with amount 2,500 USD at 03:12 AM in a foreign country was flagged as suspicious. Use simple language.”

As another example, the server may generate:
“Generate a predictive model for next quarter's revenue based on the last three years of sales data, and describe the key input features that should be used.”

As another example, the server may generate:
“User emotion is classified as ‘anger’ while reviewing a security dashboard. Propose stricter security settings and slower processing parameters to reduce risk, and summarize the impact on response time.”

The server sends such prompt sentences, along with structured data such as feature vectors and model outputs, to the generative AI model. The generative AI model returns a textual response that includes explanatory text, suggested analysis policies, or configuration proposals. The server parses the response and maps portions of the response to internal configuration updates, such as changing threshold values, enabling or disabling certain visualizations, or adjusting feature selection weights. The server also forwards human-readable parts of the response to the terminals for display. In this way, the server incorporates generative AI as a configuration and explanation engine that cooperates with the predictive and anomaly models, rather than simply as a standalone text generator.

The server uses a specific data flow architecture to reduce redundant processing. The server stores preprocessed feature data separately from raw data so that the prediction model, anomaly detection model, emotion estimation model, and generative-AI interaction module can reuse the same feature representations. The server defines clear module interfaces based on feature tensors and metadata, which minimizes the need for repeated parsing or re-encoding. By sharing intermediate results, the server reduces memory copies and inter-module communication, thereby improving cache efficiency and decreasing total execution time. This architecture constitutes an improvement in the functioning of the computer system because it optimizes internal data flows and reduces overhead that would otherwise accumulate when each model maintains separate preprocessing stages.

The server in some embodiments supports multiple domains with different domain-specific models. For example, in a financial domain, the server trains a prediction model to forecast risk scores for accounts. In a logistics domain, the server trains a prediction model to forecast stock-out dates for items. In a retail domain, the server trains an anomaly detection model to detect unusual purchase behavior. The server maintains domain identifiers and associates each data record and model with a domain. When processing requests, the server selects appropriate model instances based on domain identifiers and passes domain-specific context into prompt sentences for the generative AI model. For example, the server may send the prompt sentence:
“Generate a dashboard configuration that highlights items with less than one week of forecasted stock in a logistics environment, and include recommendations for encryption and access control settings.”

By combining domain context, emotion state information, and model outputs in the prompts, the server obtains more precise and context-appropriate responses from the generative AI model, which are then translated into concrete configuration changes. This multi-domain architecture demonstrates that the system is not limited to a single business scenario but instead provides a flexible computational framework that can be specialized by data and prompts.

The terminal, upon receiving configuration updates and visualization information from the server, adjusts its graphical user interface dynamically. The terminal changes color schemes, layout distribution, and emphasis of chart elements based on configuration parameters that may depend on emotion state information, anomaly severity, or domain policies. For instance, the terminal may display a bright color palette with larger, summary-level charts when the emotion state is joyful and anomalies are rare, and may display a darker palette with more detailed, risk-focused charts when the emotion state is angry and anomalies are frequent. Because these adjustments are driven by machine-interpretable configuration data produced by the server's internal logic, and not by manual user customization, the terminals operate as controlled visualization devices in a broader feedback loop that improves the human-computer interaction in technically measurable ways, such as reduced time to identify critical events.

In further embodiments, the server implements alternative model structures and training methods. For example, the server may implement a recurrent neural network or a transformer-type network to better exploit temporal patterns in time-series data. The server may use data augmentation techniques such as adding small amounts of noise to numeric fields or slightly perturbing timestamps to improve generalization. The server may use more complex loss functions that incorporate both prediction error and calibration measures, and may adjust learning rates adaptively over the course of training. By specifying these model structures and training methods, the system achieves higher predictive accuracy and higher anomaly detection precision than simpler, rule-based or linear models, which in turn improves technical performance metrics such as false-positive rate and processing cost per detected anomaly.

The server may also implement a rule-based overlay on top of the learned models. The server can define non-conventional rules that combine emotion state information, anomaly indices, and system resource usage metrics. For instance, the server may enforce a rule that when memory usage exceeds a threshold and emotion is neutral, the system simplifies visualizations by reducing chart densities and sampling rates, thereby lowering graphic rendering costs and freeing resources for critical computation. These composite rules, based on internal system metrics and model outputs, are not naturally performed by human operators and represent a machine-level optimization distinct from mere automation of human decision-making.

Because the server changes processing pipelines, resource allocations, security operations, and visualization behavior in response to machine-derived emotion and anomaly information, the invention improves the functioning of the computer system itself. The server reduces average latency by scaling computation in low-risk, low-stress situations, and increases safety by enforcing stricter checks in high-risk or high-stress situations. The unified data representation and shared preprocessing among multiple models reduce memory bandwidth usage and redundant computation. The closed-loop interaction with a generative AI model allows automatic adjustment of internal parameters in response to complex conditions that would be difficult to encode by static rules alone. These improvements collectively produce technical effects such as higher throughput, lower error rates, improved detection performance, and reduced communication and rendering overhead, thereby demonstrating that the invention is directed to a technological solution and not merely to an abstract automation of human business processes.

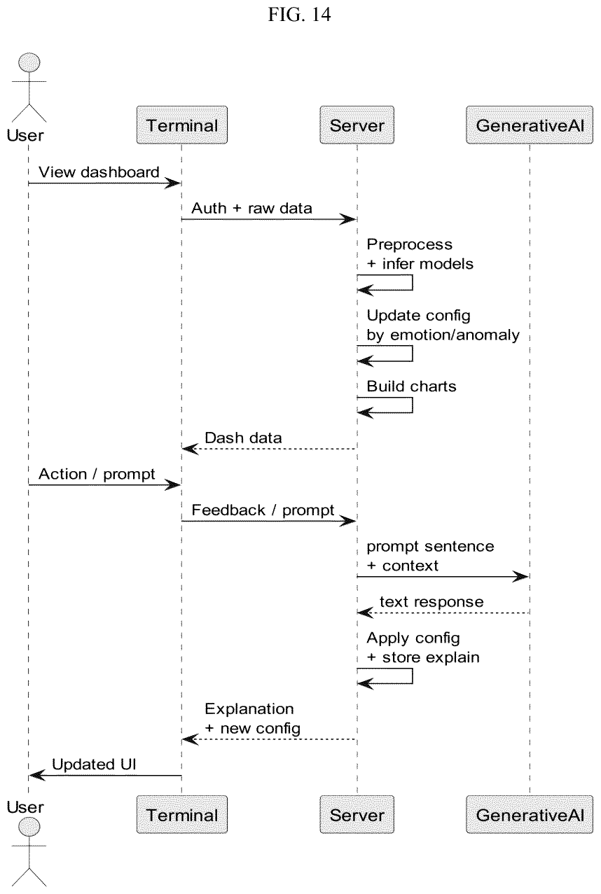

The following describes the processing flow using FIG. 14.

### Step 1

Server receives raw data from terminals and external sources.

Server takes as input sensor streams (voice audio, image frames), user interaction events, time-series logs, transaction records, inventory records, and usage history records, which are transmitted from terminals and external systems over a secure communication protocol. Server parses incoming messages, validates required fields such as timestamps and identifiers, and stores the raw records into a persistent data store. Server thereby transforms network packets into structured raw records, assigning unique record IDs and associating domain tags such as financial, logistics, or retail as metadata.

### Step 2

Server preprocesses raw data into feature data.

Server takes as input the raw records stored in the data store and reads them into a data-frame structure. Server performs data cleaning by removing malformed records and filling missing numeric values using computed per-feature statistics such as means and medians. Server then applies normalization to numeric fields by subtracting per-feature means and dividing by per-feature standard deviations, and applies encoding to categorical fields by converting them into one-hot vectors or integer indices. Server outputs feature data represented as dense numerical tensors suitable for efficient batch computation on a processor or graphics processing unit.

### Step 3

Server trains prediction and anomaly detection models.

Server takes as input the feature data from Step 2 together with ground-truth labels such as actual future values or normal/abnormal flags stored in the data store. Server divides the input into training, validation, and test subsets. Server executes training procedures for a prediction model, for example a feed-forward neural network, and for an anomaly detection model, for example an autoencoder, by repeatedly performing forward passes to compute model outputs, computing loss values such as mean squared error or cross-entropy, computing gradients via backpropagation, and updating model weights using a gradient-based optimizer. Server outputs trained model parameter sets and model artifacts and stores them for later inference use.

### Step 4

Server performs emotion estimation from audio and image data.

Server takes as input audio frames and image frames transmitted by terminals, each associated with user session identifiers and timestamps. Server extracts acoustic features from the audio, such as pitch contours, energy levels, and spectral coefficients, using an audio processing library, and extracts visual features from the images, such as facial landmarks or face embeddings, using an image processing library. Server feeds these feature vectors into an emotion estimation model comprising neural network classifiers and, if present, a fusion layer that combines audio-based and image-based predictions. Server outputs emotion state information consisting of an emotion label such as joy, anger, or neutral and a confidence score and stores this information in an emotion state store linked to the corresponding user sessions.

### Step 5

Server executes prediction and anomaly detection on live feature data.

Server takes as input new feature data generated in real time from incoming raw records and the trained model artifacts from Step 3. Server applies the prediction model to the feature data to obtain prediction results, such as forecasted numeric values or classification probabilities, and applies the anomaly detection model, such as an autoencoder, to compute reconstruction errors that serve as anomaly indices. Server compares each anomaly index with a predetermined threshold, which may be derived from validation data statistics, and classifies records as normal or anomalous based on this comparison. Server outputs prediction results, anomaly indices, and anomaly flags, and stores them together with the corresponding record identifiers.

### Step 6

Server dynamically adjusts processing and security parameters.

Server takes as input the prediction results and anomaly flags from Step 5 and the emotion state information from Step 4. Server evaluates decision rules that combine anomaly severity, emotion label, and system resource metrics such as current CPU usage. Based on these inputs, server performs data computations to select new values for internal parameters including batch size, model invocation frequency, logging level, encryption strength, and access control strictness. For example, when emotion is joy and anomaly indices are low, server increases batch size and reduces redundant verification steps; when emotion is anger and anomaly indices are high, server reduces batch size, enables additional validation modules, and enforces more restrictive access policies. Server outputs updated configuration settings that are applied to the processing pipeline and security modules.

### Step 7

Server generates visualization information for real-time dashboards.

Server takes as input prediction results, anomaly indices, anomaly flags, and emotion state information, along with existing visualization configuration templates. Server performs data aggregation operations such as computing time-windowed averages, counts of anomalies per category, and distributions of emotion states across users. Server then assembles chart configurations including axis ranges, color schemes, and layout positions, and binds aggregated data to these configurations. Server outputs visualization information comprising chart data structures and display parameters and transmits this information to terminals for rendering.

### Step 8

Terminal renders emotion-adaptive dashboard user interfaces.

Terminal takes as input the visualization information and configuration parameters transmitted by the server, including color schemes, layout definitions, and emphasis rules tied to emotion state and anomaly severity. Terminal parses this input, constructs chart objects such as line graphs, bar charts, and tables using a graphical framework, and applies color palettes and layout changes specified by the server. Terminal updates existing dashboard screens or creates new views, for example by highlighting anomaly-related panels when anomaly counts exceed thresholds or by using brighter themes when emotion is joy. Terminal outputs rendered graphical user interfaces on the display for the user to view.

### Step 9

Server and terminal enforce encryption and access control.

Server takes as input user authentication credentials and access tokens received from terminals, together with requests for data or dashboards. Server verifies the authenticity and validity of the tokens, checks associated roles and permissions, and consults internal security policies. Server applies encryption processing to sensitive payloads by transforming plaintext data into ciphertext using a symmetric encryption algorithm before storage or transmission. Terminal takes as input the ciphertext payloads and, depending on the configuration, may request server-side decryption or perform client-side decryption as authorized. Server and terminal output securely transmitted and access-controlled data, thereby ensuring that only authorized users can view or manipulate specific dashboards and records.

### Step 10

User interacts with dashboards and sends feedback.

User takes as input the rendered dashboard screens on the terminal display. User reviews prediction results, anomaly alerts, and explanatory texts and then performs actions such as tapping buttons labeled “Confirm transaction,” “Report fraud,” “Approve restocking,” or “Request explanation.” Terminal takes these actions as input, converts them into structured feedback messages including identifiers of the related records and actions, and transmits them to the server. Server receives this feedback and outputs updated records that include user feedback labels stored in a feedback repository.

### Step 11

Server incorporates user feedback into model refinement.

Server takes as input feedback labels generated in Step 10 and the corresponding historical feature data and model outputs. Server merges these labels into training data sets, marking certain records as true anomalies, false positives, or particularly useful predictions. Server then retrains or fine-tunes the prediction and anomaly detection models by rerunning the training procedure with the extended labeled data, recomputing gradients and updating model weights to reduce classification errors or prediction deviations. Server outputs refined model versions with improved performance metrics, and updates the active models used in Step 5, thereby closing a feedback loop that enhances accuracy over time.

### Step 12

Server constructs prompt sentences for the generative AI model.

Server takes as input prediction results, anomaly indices, anomaly flags, emotion state information, domain identifiers, and optionally user feedback from previous steps. Server executes a prompt construction routine that selects relevant fields and embeds them into natural-language templates. For example, server may generate the prompt sentence:
“Explain why this transaction with amount 2,500 USD at 03:12 AM in a foreign country was flagged as suspicious. Use simple language.”

As another example, server may generate the prompt sentence:
“User emotion is classified as ‘anger’ while viewing the security dashboard. Propose stricter security settings and reduced processing speed to lower risk, and summarize the expected impact.”

Server outputs textual prompt sentences that capture both machine state and user context, and passes these prompts, together with structured context data, to the generative AI model interface.

### Step 13

Server obtains generative AI responses and maps them to configuration and explanations.

Server takes as input prompt sentences and associated structured data sent to the generative AI model and receives as output textual responses from the generative AI model. Server parses the responses, using pattern matching or lightweight natural language processing, to extract suggested explanation text, analysis policies, and configuration values such as threshold adjustments or visualization changes. Server computes mappings from the extracted suggestions to concrete internal parameters, for example updating numerical thresholds or enabling or disabling specific dashboards. Server outputs two types of results: machine-interpretable configuration updates applied to internal modules and human-readable explanatory texts forwarded to terminals for display to users.

### Step 14

Terminal displays generative-AI-based explanations to the user.

Terminal takes as input the explanatory texts and any additional instructions received from the server after Step 13. Terminal formats these texts into readable layouts, such as tooltips attached to anomaly alerts or side panels describing reasons for a model decision. Terminal may also attach control elements, such as “Accept suggested configuration” buttons, to let users confirm or reject configuration changes. Terminal renders these explanations and controls on the display and outputs updated user interfaces that clarify system behavior to the user.

### Step 15

User issues direct prompt sentences to request analyses or configurations.

User takes as input the visible interface elements inviting text entry for advanced queries. User types prompt sentences, for example:
“Generate a predictive model for next quarter's revenue based on the last three years of sales data.” or
“Show which factors most strongly influenced the fraud score for this transaction.”

Terminal takes these prompt sentences as input, wraps them with metadata such as session identifiers and domain identifiers, and sends them to the server. Server receives the prompt sentences and outputs interpreted intents and, when appropriate, new analytics executions or configuration updates produced through cooperation between internal models and the generative AI model.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

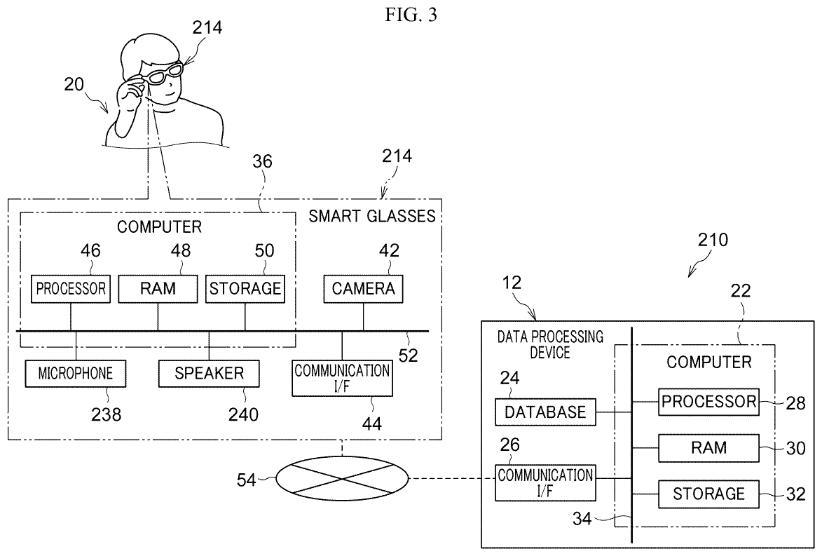

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

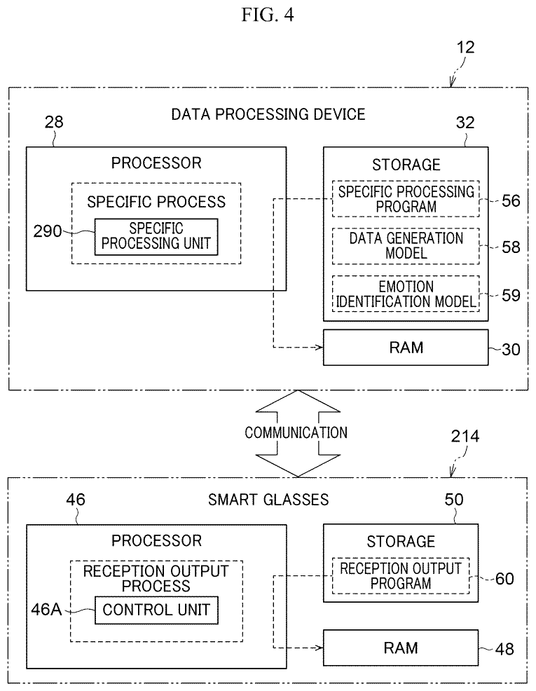

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

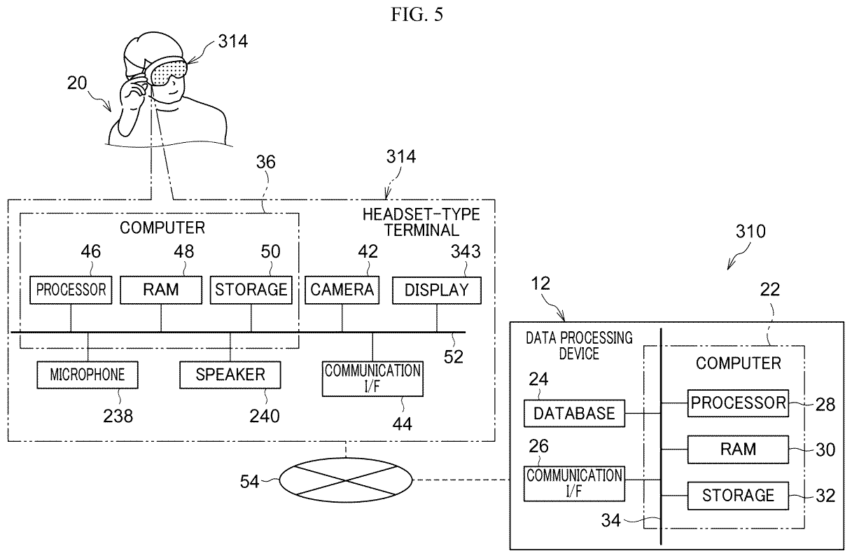

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

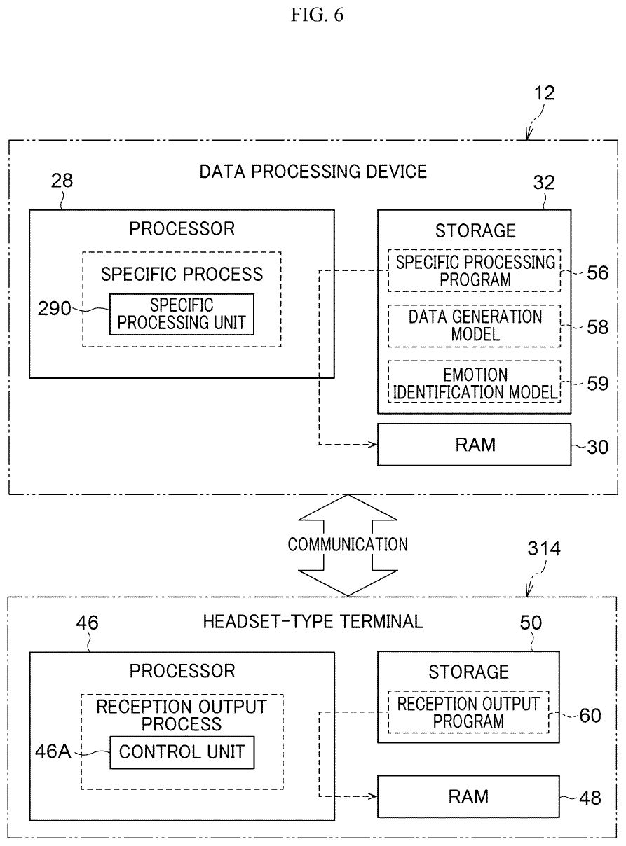

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

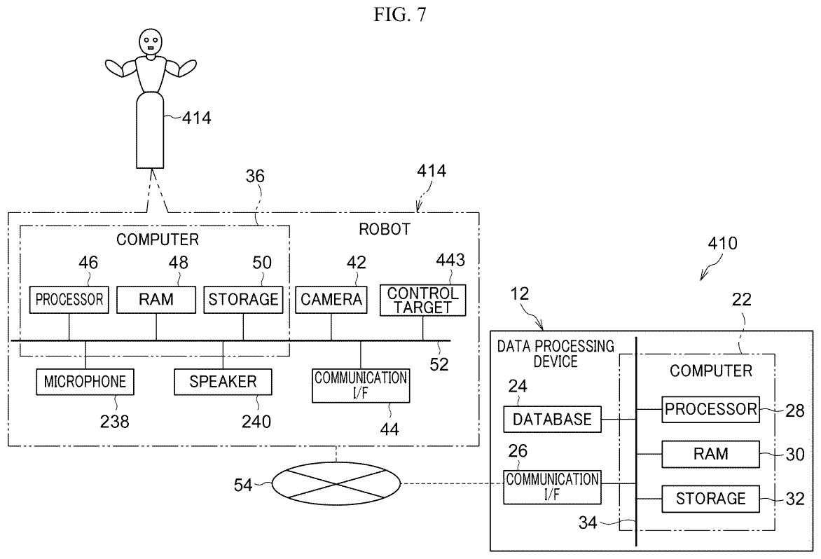

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

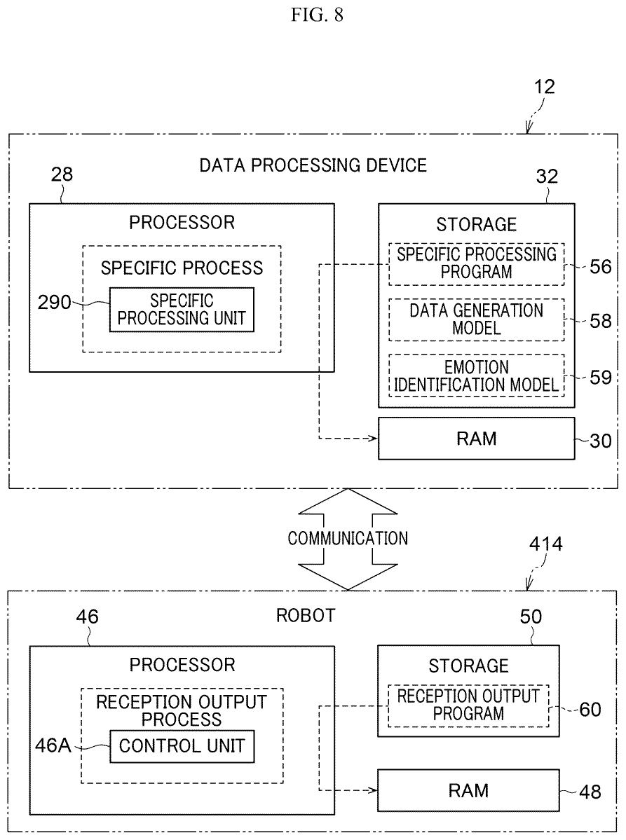

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

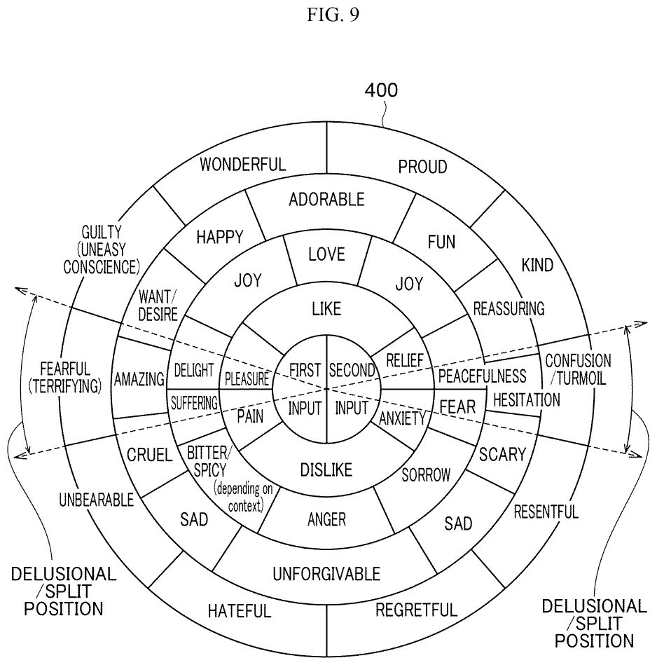

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379:“Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

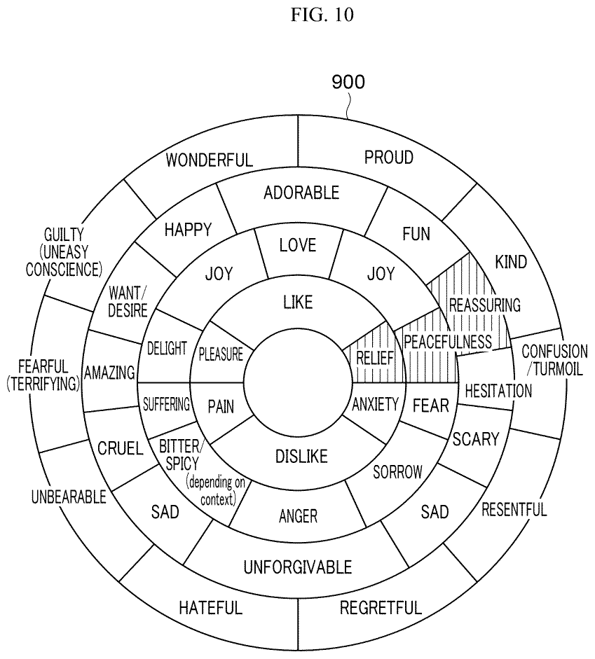

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor,
wherein the processor is configured to
receive data from a terminal via an input device and store the data in a storage device,
determine a type of the stored data, perform preprocessing including at least missing-value completion, normalization, and encoding for tabular data, and perform preprocessing including at least size conversion, pixel-value normalization, and color-space conversion for image data, thereby generating preprocessed data,
input the preprocessed data to a machine learning model executed by a parallel computation device, and perform data analysis processing including at least one of feature extraction, classification, prediction, and anomaly detection,
acquire a prompt sentence in natural language input from the terminal, and execute task-interpretation processing that specifies at least one of a target attribute, an analysis task, and
an output format of the data analysis processing based on contents of the prompt sentence, select or configure the machine learning model or an analysis algorithm in accordance with content specified by the task-interpretation processing, and dynamically control an analysis pipeline for the preprocessed data based on the selection or configuration,
execute a generative AI model using the prompt sentence, a result of the data analysis processing, and related metadata as inputs, and generate natural-language explanation information including at least a summary, a rationale, and a commentary regarding the analysis result,
generate visualization data including, for tabular data, list information, statistical information, and graph information, and including, for image data, region-highlighting information and annotation information, based on the result of the data analysis processing and the natural-language explanation information, and transmit the visualization data to the terminal in real time, and
execute information-protection processing including at least prevention of unauthorized access, encryption, and access control for the data and the analysis result.

### (Supplementary 2)

The system according to supplementary 1,
wherein the processor is configured to cause the generative AI model, in generating the natural-language explanation information, to generate an explanation including at least one of: a reason for extraction of an anomalous value, a selection condition for a detected object, an analysis result of a trend and seasonality of time-series data, and a proposed countermeasure for a user, in accordance with contents of the prompt sentence.

### (Supplementary 3)

The system according to supplementary 1,
wherein the processor is configured to execute the task-interpretation processing based on the prompt sentence or configuration information indicating at least a data type, an attribute, and
an evaluation index specific to an industrial field, determine an analysis task and a model configuration specialized for a specific field, and construct or update, using the machine learning model and the generative AI model, a data-analysis model and an explanation-generation model specialized for the specific field.

### Application Example 1

### (Supplementary 1)

A system comprising a processor,
wherein the processor is configured to
acquire time-series data indicative of inventory states of articles from a plurality of information sources, convert records representing the inventory states into a standardized internal format, and store the records in a storage device for accumulation,
use historical time-series data relating to past inventory states stored in the storage device to train a prediction model, input current time-series data relating to inventory states into the prediction model, numerically predict future inventory transitions over a predetermined period, and extract target items that are likely to experience inventory shortage or inventory excess,
generate, for each of the extracted target items, structured analysis result data including at least a predicted occurrence time of the inventory shortage or the inventory excess, a predicted minimum or maximum inventory quantity, and a recommended quantity for replenishment or reduction, based on the predicted future inventory transitions and predetermined reference values,
input a prompt sentence to a generative information processing model while appending the structured analysis result data as context information, and cause the generative information processing model to execute a generation process of a description or recommendation in natural language,
transmit response data including the description or recommendation in natural language output from the generative information processing model and the structured analysis result data to an information display device via an output communication device, and
generate display control information for causing the information display device to visually display at least an inventory state, a future inventory transition, an inventory risk, and the description or recommendation in natural language included in the response data.

### (Supplementary 2)

The system according to supplementary 1,
wherein the processor is configured to
implement the prediction model as a regression-type numerical prediction model that receives the time-series data relating to inventory states as input and outputs future inventory quantities as continuous values, automatically determine inventory shortage risk and inventory excess risk by comparing prediction results of the regression-type numerical prediction model with a safety inventory level and a storage capacity level, and include a determination result as part of the context information input to the generative information processing model.

### (Supplementary 3)

The system according to supplementary 1,
wherein the processor is configured to
receive, via an input reception function, a prompt sentence input by a user, generate the prompt sentence to be input to the generative information processing model by combining the prompt sentence input by the user with an instruction sentence automatically generated by the system based on the time-series data relating to inventory states and prediction results, and
cause the generative information processing model, through input and output processing to and from the generative information processing model, to dynamically generate a description or recommendation in natural language relating to inventory management in accordance with a request content of the user.

### Example 2

### (Supplementary 1)

A system comprising a processor,
wherein the processor is configured to
acquire, from a user terminal, a data set including a plurality of types of historical information related to an application domain, and store the data set in a storage device,
perform preprocessing on the data set by using a data processing program to generate preprocessed data, the preprocessing including completion of missing information, removal of anomalous information, and unification of information formats,
perform feature extraction processing and standardization processing on the preprocessed data by using a feature transformation program to generate feature data suitable for machine learning processing, the feature extraction processing and the standardization processing including encoding of classification information and normalization of numerical information,
train a prediction model based on the feature data and teacher information included in the data set by using a machine learning program, and generate an application-domain-specific prediction model by changing configuration elements and learning conditions of the prediction model in a plurality of patterns and selecting the prediction model based on performance indicators,
perform performance evaluation of the prediction model by inputting evaluation data to the prediction model, calculating accuracy, recall, and index values, and, based on the performance evaluation, resetting at least a part of the preprocessing, the feature extraction processing, or the learning conditions and retraining the prediction model,
generate a prompt sentence regarding specifications and processing procedures of the prediction model according to a usage purpose in the application domain, input the prompt sentence to a generative information processing model, cause the generative information processing model to generate program code or configuration information for automatically executing the preprocessing, the feature extraction processing, learning processing of the prediction model, and the performance evaluation processing, and execute or apply the generated program code or configuration information on the system, and
provide the generated prediction model or an analysis result obtained by using the prediction model in response to a request from an external device.

### (Supplementary 2)

The system according to supplementary 1,
wherein the processor is configured to input, to the generative information processing model, the prompt sentence including a description of a processing for estimating an occurrence probability of an event in a prediction period by using historical information over a past period, a description of contents of the preprocessing and the feature extraction processing, a description of a learning algorithm and evaluation indicators of the prediction model, and a description of specifications of an information providing interface for calling the prediction model from the external device.

### (Supplementary 3)

The system according to supplementary 1,
wherein the processor is configured to manage the data set separately for each application domain including at least one of a claim domain, a financial domain, and an insurance domain, and automatically switch and execute, for each application domain, the feature extraction processing and the learning processing of the prediction model based on the program code or the configuration information acquired from the generative information processing model.

### Application Example 2

### (Supplementary 1)

A system comprising a processor,
wherein the processor is configured to
perform parallel processing on data to execute high-speed processing; and
train a machine learning model using past data sets to generate a prediction model or an anomaly detection model; and
preprocess time-series data, transaction data, inventory data, or usage history data to generate feature data by performing at least missing-value completion, normalization, and encoding; and
execute the prediction model or the anomaly detection model based on the feature data to calculate a prediction result or an anomaly index and to identify an anomalous event by comparing the prediction result or the anomaly index with a predetermined threshold; and execute an emotion estimation model to generate emotion state information by estimating a user's emotional state based on voice information or image information acquired from a user terminal; and
dynamically adjust at least one of a data processing speed, a data analysis policy, an information visualization format, and an information security level based on the emotion state information and the prediction result or the anomaly index; and generate visualization information that is displayable as a real-time dashboard screen while protecting the data and the prediction result by encryption processing and access control processing; and
input a prompt sentence relating to at least one of the prediction result, the anomaly index, and the emotion state information to a generative AI model, obtain a response including at least one of an explanatory text, an analysis policy, and configuration information from the generative AI model, and reflect the response in an operation of the processor or in an operation of the user terminal.

### (Supplementary 2)

The system according to supplementary 1,
wherein the processor is configured to
receive, in real time, at least one of transaction information, inventory information, and business information, sequentially execute the prediction model or the anomaly detection model to generate at least one of warning information regarding an anomalous event and forecast information regarding future demand, and change display content and display format of the warning information or the forecast information in accordance with the emotion state information.

### (Supplementary 3)

The system according to supplementary 1,
wherein the processor is configured to
train the machine learning model using a domain-specific data set in at least one of a financial domain, a logistics domain, and a retail operation domain, so as to generate a prediction model or an anomaly detection model specialized for data analysis in a specific domain, and to input to the generative AI model a prompt sentence including information on the specific domain and the emotion state information so as to cause the generative AI model to generate at least one of a domain-specific explanatory text and an operation policy.

What is claimed is:

1. A system comprising:
circuitry configured to:
receive, via a communication interface coupled to a packet-switched network, input data from a terminal device and store the input data in a storage device;
determine a data type of the input data, perform preprocessing on the input data comprising at least missing-value completion, normalization, and encoding to generate preprocessed data;
input the preprocessed data to a machine learning model executed by a parallel computation device, and perform data analysis processing comprising at least one of feature extraction, classification, prediction, or anomaly detection;
acquire a prompt sentence in natural language from the terminal device, and execute task-interpretation processing that specifies at least one of a target attribute, an analysis task, or an output format of the data analysis processing based on contents of the prompt sentence;
execute a generative neural network model using the prompt sentence, a result of the data analysis processing, and related metadata as inputs, and generate natural-language explanation information comprising at least a summary, a rationale, and a commentary regarding the analysis result; and
generate visualization data based on the result of the data analysis processing and the natural-language explanation information, and transmit a notification data packet comprising the visualization data to the terminal device via the communication interface.

2. The system according to claim 1, wherein the circuitry is configured to select or configure the machine learning model or an analysis algorithm in accordance with content specified by the task-interpretation processing, and dynamically control an analysis pipeline for the preprocessed data based on the selection or configuration.

3. The system according to claim 2, wherein the circuitry is configured to execute the task-interpretation processing based on configuration information indicating at least a data type, an attribute, and an evaluation index specific to a target domain, and to construct or update a data-analysis model specialized for the target domain.

4. The system according to claim 1, wherein the parallel computation device comprises a graphics processing unit configured to execute a plurality of computation threads simultaneously, and wherein the circuitry distributes the preprocessed data across the plurality of computation threads for concurrent analysis processing.

5. The system according to claim 4, wherein the circuitry is configured to partition the preprocessed data into a plurality of data segments, assign each data segment to a respective computation thread, and aggregate partial results from the computation threads into a consolidated analysis result.

6. The system according to claim 1, wherein the preprocessing for tabular data comprises missing-value completion, normalization, and encoding of categorical values, and the preprocessing for image data comprises size conversion, pixel-value normalization, and color-space conversion.

7. The system according to claim 1, wherein the circuitry is configured to train the machine learning model using past data sets stored in the storage device by executing a learning process comprising at least feature extraction, model parameter optimization, and performance evaluation based on accuracy, recall, and index values.

8. The system according to claim 7, wherein the circuitry is configured to change configuration elements and learning conditions of the machine learning model in a plurality of patterns, evaluate performance of each pattern, and select the machine learning model based on the performance evaluation.

9. The system according to claim 7, wherein the circuitry is configured to, based on the performance evaluation, reset at least one of the preprocessing, feature extraction processing, or learning conditions and retrain the machine learning model.

10. The system according to claim 1, wherein the generative neural network model comprises a transformer-based architecture including multiple self-attention layers and feed-forward layers, and wherein the circuitry is configured to generate the natural-language explanation information comprising at least one of a reason for extraction of an anomalous value, a selection condition for a detected object, an analysis result of a trend and seasonality of time-series data, or a proposed countermeasure.

11. The system according to claim 1, wherein the visualization data comprises, for tabular data, at least one of list information, statistical information, or graph information, and for image data, at least one of region-highlighting information or annotation information.

12. The system according to claim 1, wherein the circuitry is configured to execute information-protection processing comprising at least prevention of unauthorized access, encryption, and access control for the input data and the analysis result.

13. The system according to claim 1, wherein the circuitry is configured to acquire time-series data from a plurality of information sources, convert records into a standardized internal format, store the records in the storage device, and train a prediction model using historical time-series data to predict future transitions over a predetermined period.

14. The system according to claim 13, wherein the circuitry is configured to extract target items that are likely to experience a shortage or an excess based on the predicted future transitions and predetermined reference values, and to generate structured analysis result data comprising at least a predicted occurrence time, a predicted quantity, and a recommended adjustment quantity.

15. The system according to claim 14, wherein the circuitry is configured to input the prompt sentence to the generative neural network model while appending the structured analysis result data as context information, and to cause the generative neural network model to generate a description or recommendation in natural language.

16. The system according to claim 1, wherein the circuitry is configured to generate a prompt sentence regarding specifications and processing procedures of the machine learning model, input the prompt sentence to the generative neural network model, and cause the generative neural network model to generate at least one of program code or configuration information for automatically executing the preprocessing, feature extraction, training, or performance evaluation.

17. The system according to claim 1, wherein the circuitry is configured to receive the prompt sentence from the terminal device and combine the prompt sentence with an instruction sentence automatically generated based on the input data and the analysis result to form a combined prompt sentence for input to the generative neural network model.

18. A system comprising:
circuitry configured to:
receive, via a communication interface coupled to a packet-switched network, input data from a terminal device, determine a data type, and perform preprocessing comprising missing-value completion, normalization, and encoding to generate preprocessed data;
input the preprocessed data to a machine learning model executed by a parallel computation device comprising a graphics processing unit, distribute computation across a plurality of threads, and perform data analysis processing comprising at least one of feature extraction, classification, prediction, or anomaly detection;
acquire a prompt sentence from the terminal device, execute task-interpretation processing to specify a target attribute, an analysis task, and an output format, and dynamically select or configure the machine learning model or an analysis algorithm based on the task-interpretation processing;
execute a generative neural network model comprising a transformer-based architecture using the prompt sentence, the analysis result, and metadata as inputs, and generate natural-language explanation information comprising a summary, a rationale, and a commentary;
generate visualization data comprising at least one of list information, statistical information, graph information, region-highlighting information, or annotation information, and transmit a notification data packet comprising the visualization data and the natural-language explanation information to the terminal device; and
execute information-protection processing comprising at least encryption and access control for the input data and the analysis result.

19. The system according to claim 18, wherein the circuitry is configured to train the machine learning model using past data sets by changing configuration elements in a plurality of patterns, evaluating performance of each pattern, and selecting the machine learning model having optimal performance indicators.

20. A method comprising:
receiving, via a communication interface coupled to a packet-switched network, input data from a terminal device and storing the input data in a storage device;
determining a data type of the input data, performing preprocessing on the input data comprising at least missing-value completion, normalization, and encoding to generate preprocessed data;
inputting the preprocessed data to a machine learning model executed by a parallel computation device, and performing data analysis processing comprising at least one of feature extraction, classification, prediction, or anomaly detection;
acquiring a prompt sentence in natural language from the terminal device, and executing task-interpretation processing that specifies at least one of a target attribute, an analysis task, or an output format of the data analysis processing based on contents of the prompt sentence;
executing a generative neural network model using the prompt sentence, a result of the data analysis processing, and related metadata as inputs, and generating natural-language explanation information comprising at least a summary, a rationale, and a commentary regarding the analysis result; and
generating visualization data based on the result of the data analysis processing and the natural-language explanation information, and transmitting a notification data packet comprising the visualization data to the terminal device via the communication interface.
